(19) United States
(12) Patent Application Publication
(10) Pub. No.: US 2007/0071425 A1
(43) Pub. Date: Mar. 29, 2007

(54) Sensing apparatus, program execution apparatus and image-taking system

(75) Inventors: Kazuyuki Horinouchi, Iga-Shi (JP); Hiroshi Kubo, Soraku-gun (JP); Masashi Shiomi, Iga-Shi (JP); Katsubumi Koyanagi, Nara-Shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/527,450

(22) Filed: Sep. 27, 2006

(30) Foreign Application Priority Data
Sep. 27, 2005 (JP) 2005-279661

(51) Int. Cl. G03B 17/00

(52) U.S. Cl. 396/54

(57) ABSTRACT

A sensing apparatus for detecting a predetermined type of physical information which changes in accordance with an external factor, such as an operation force from the outside or the like, includes a camera, an attachment which includes a subject which changes a state thereof in accordance with the external factor, and a CPU which detects the physical information described above based on image data from the camera. For example, as the subject, a globe is provided which is arranged on a concave surface. Tilting of a case fitted with the attachment causes the globe to move on the surface. The CPU, from the image data, analyzes the position of the globe and detects the inclination of the case.

This nonprovisional application claims priority under 35 U.S.C. § 119(a) on Patent Application No. 2005-279661 filed in Japan on Sep. 27, 2005, the entire contents of which are hereby incorporated by reference.

### BACKGROUND OF THE INVENTION

1. Field of the Invention

The present invention relates to a sensing apparatus for detecting physical information, such as the degree of inclination, the magnitude of pressure, or the like, also to a program execution apparatus, such as a game apparatus or the like, and further to an image taking system provided with the same function as that of a digital camera or the like.

2. Description of Related Art

Game systems have been developed which change the state of game space in accordance with inclination, impact, or the like, added to a controller or a case of a game apparatus. The game apparatus of this type detects required physical information (inclination or the like) by being loaded with a special sensor component. Thus, to obtain a new physical information of a different type (acceleration or the like), an additional special sensor component for this information needs to be separately loaded in the game apparatus. Providing a plurality of special sensor components in accordance with the type of a game leads to enormous increase in costs and the apparatus size.

Game apparatuses have been developed which have a sensor function provided on the game cartridge side (see, for example, JP-A-2001-170358). FIG. 17 is a block diagram showing the electrical configuration of a game apparatus body 301 and a game cartridge 330 in a game apparatus of this type.

The game apparatus body 301 is composed of: an LCD panel 304 for displaying a game screen, a switch group 305 for performing game operation, a CPU (Central Processing Unit) 311, an audio control part 312 , a communication interface (I/F) 313, a work RAM (Random Access Memory) 314, and a speaker 315.

The game cartridge 330 is provided with: a program ROM (Read Only Memory) 331 and a backup RAM (Random Access Memory) 332, and a XY-axes acceleration sensor 333 for detecting the acceleration in X-axis and Y-axis directions, and a Z-axis contact switch 334 for detecting the acceleration in Z-axis direction, and a sensor interface (I/F) 335 for transmitting the detection results obtained by the XY-axes acceleration sensor 333 and the Z-axis contact switch 334 to the CPU 311.

As described above, providing a plurality of special sensor components in the game apparatus in accordance with the game type leads to enormous increase in costs and in the apparatus size. In addition, as shown in FIG. 17, constructing the game apparatus resultingly requires a sensor component for each cartridge, thus leading to large cost burden.

### SUMMARY OF THE INVENTION

In view of the point described above, it is an object of the present invention to provide a sensing apparatus capable of detecting desired physical information (inclination or the like) with low-cost configuration, to provide a program execution apparatus provided with such a sensing apparatus, and to provide a user-friendly image taking system.

To achieve the object described above, one aspect of the invention refers to a sensing apparatus for detecting physical information of a predetermined type which changes in accordance with an external factor. The sensing apparatus includes: an image taking part; a subject state change part which includes a subject of the image taking part and which changes a state of the subject in accordance with the external factor; and a detection part which detects the physical information based on image data obtained by photographing the subject by the image taking part.

The physical information to be detected changes in accordance with the external factor (an operation force from the outside or the like). On the other hand, a state of the subject of the image taking part changes in accordance with the external factor. The state of the subject is represented by the image data; thus, the physical information can be detected based on this image data.

In this manner, the sensing apparatus described above can use image taking function of the image taking part to thereby detect physical information of a predetermined type, thus permitting desired detection with very low-cost configuration especially in a system previously provided with an image taking part.

For example, the subject state change part is fitted in a freely attachable and detachable manner to a case fitted with the image taking part.

More specifically, for example, as the subject state change part, there are at least a first subject state change part and a second subject state change part; the first subject state change part includes as the subject a first subject of the image taking part, and changes a state of the first subject in accordance with a first external factor as the external factor; the second subject state change part includes as the subject a second subject of the image taking part, and changes a state of the second subject in accordance with a second external factor as the external factor; the first and second subjects are different from each other, and the first external factor and the second external factor are external factors of mutually different types; the first and second subject state change parts are fitted in a freely attachable and detachable manner and also selectively to the case fitted with the image taking part; and when the first subject state change part is fitted to the case, the detection part detects first physical information as the physical information based on image data obtained by photographing the first subject, and when the second subject state change part is fitted to the case, the detection part detects, as the physical information, second physical information of a type different from that of the first physical information based on image data obtained by photographing the second subject.

Replacement of the subject state change part fitted to the case described above also changes detectable physical information. That is, the use of the image taking part and the detection part described above (that is, with very low-cost configuration) permits detection of various types physical information.

For example, the subject state change part includes as the subject a moving body that moves within a photographing region of the image taking part in accordance with inclination of a case fitted with the image taking part; the external factor is a force which changes the inclination; and the detection part detects, based on the image data, detects at least one of a position and movement of the moving body in the photographing region to thereby detect as the physical information at least one of a degree of the inclination and a change thereof.

A change in the inclination of the case described above causes the moving body described above to move in the photographing region. The position and movement of the moving body in the photographing region is represented by the image data; thus, the degree of the inclination and/or a change thereof can be detected based on the image data.

Specifically, for example, the subject state change part has a convex or concave surface provided in the photographing region of the image taking part; and the moving body moves along the surface by gravity force when the inclination changes.

For example, the subject state change part includes a surface provided in a photographing region of the image taking part and, as the subject, a moving body which is movable on the surface; the external factor is a force which changes a position of the moving body on the surface; and the detection part, based on the image data, detects as the physical information at least one of the position and movement of the moving body in the photographing region.

The force described above, such as the operation force from the outside or the like, changes the position of the moving body described above. The position and movement of the moving body in the photographing region is represented by the image data; thus, the position and/or movement of the moving body can be detected based on this image data.

For example, the subject state change part includes, as the subject, a magnet provided in a photographing region of the image taking part so as to be rotatable in accordance with a direction of a magnetic field; the external factor is a magnetic force by the magnetic field which rotates the magnet; and the detection part, based on the image data, detects a direction of the magnetic force as the physical information.

The magnet described above is rotated by the magnetic force by the magnetic field described above. The direction of the magnet described above is represented by the image data; thus, the direction of the magnetic force described above can be detected based on this image data.

For example, the subject state change part includes: a rotation axis, and a plurality of blades as the subject which is arranged in a photographing region of the image taking part and which is so fitted as to be rotatable with the rotation axis as a central axis; the external factor is a force which rotates the a plurality of blades; and the detection part, based on the image data, detects a rotation state of the plurality of blades as the physical information.

The force described above, such as the operation force from the outside, a wind power, or the like, rotates the plurality of blades described above. The rotation state of the plurality of blades is represented by the image data; thus, this rotation state can be detected based on this image data.

For example, the subject state change part includes, as the subject, a pressure deformable body which is arranged in a photographing region of the image taking part and which changes a shape thereof in accordance with magnitude of pressure applied thereto; the external factor is the pressure applied to the pressure deformable body; and the detection part, based on the image data, detects the magnitude of the pressure as the physical information.

The shape of the pressure deformable body described above changes in accordance with the magnitude of the pressure described above. The condition of this deformation is represented by the image data; thus, the magnitude of the pressure can be detected based on this image data.

Specifically, for example, the subject state change part includes an upper plate and a lower plate which sandwich an elastic body as the pressure deformable body, and is configured so that a contact area between the pressure deformable body and the lower plate changes in accordance with the magnitude of the pressure applied to the pressure deformable body via the upper plate; and the detection part, based on the image data, calculates the contact area, and based on the calculated contact area, detects the magnitude of the pressure as the physical information.

For example, the subject state change part includes, as the subject, a plurality of pressure deformable bodies which change a shape thereof depending on magnitude of pressure applied thereto; the plurality of pressure deformable bodies are arranged at mutually different positions in a photographing region of the image taking part; the external factor is the pressure applied to the plurality of pressure deformable bodies; and the detection part, based on the image data, detects, as the physical information, the magnitude of the pressure and a position where the pressure has been applied.

The plurality of pressure deformable bodies are arranged at the mutually different positions in the photographing region; thus, the shape of each of these pressure deformable bodies changes in accordance with the magnitude of the pressure and the position where the pressure has been applied. The condition of the deformation of each of the pressure deformable bodies is represented by the image data; thus, the magnitude of this pressure and the position where the pressure has been applied can be detected based on this image data.

Specifically, for example, the subject state change part includes an upper plate and a lower plate which sandwich at mutually different positions elastic bodies as the respective pressure deformable bodies, and is configured so that a contact area between each of the plurality of pressure deformable bodies and the lower plate changes in accordance with the magnitude of the pressure applied to each of the pressure deformable bodies via the upper plate and also in accordance with a position where the pressure has been applied; and the detection part, based on the image data, calculates each contact area, and based on each contact area calculated, detects as the physical information the magnitude of the pressure and the position where the pressure has been applied.

For example, the subject state change part further includes a rod-shaped body which is fitted to the upper plate, and is configured so that the pressure is applied to each of the pressure deformable bodies via the rod-shaped body.

For example, the subject state change part includes as the subject a moving body which moves in a photographing region of the image taking part in accordance with acceleration of a case fitted with the image taking part; the external factor is a force which changes a degree of the acceleration; and the detection part, based on the image data, detects as the physical information at least one of the magnitude and a direction of the acceleration.

The force described above, such as the operation force from the outside or the like, changes the acceleration of the case, so that the moving body described above moves in the photographing region. The condition of this movement is represented by the image data; thus, the degree and/or direction of the acceleration can be detected based on this image data.

Specifically, for example, the subject state change part further includes a first and a second elastic body which are so provided as to be capable of extending and contracting in a direction which changes the acceleration, and is configured so that with each one end of the first and second elastic bodies fixed, another ends of the first and second elastic bodies sandwich the moving body.

According to this configuration, the movement of the moving body accompanied by extension and contraction of the first and second elastic bodies occurs in accordance with the acceleration of the case.

For example, the subject state change part includes as the subject a rotary body which rotates in a photographing region of the image taking part; the external factor is a force which rotates the rotary body; and the detection part, based on the image data, detects a rotation state of the rotary body as the physical information.

The force described above, such as the operation force from the outside or the like, rotates the rotary body described above. The condition of this rotation is represented by the image data; thus, the rotation state of the rotary body can be detected based on this image data.

For example, the subject state change part includes a temperature indicating material which is arranged in a photographing region of the image taking part and which changes a color thereof in accordance with a temperature of an object to be measured; the external factor is heat energy from a heat source which changes the temperature; and the detection part, based on the image data, detects the temperature as the physical information.

The state of the color of the temperature indicating material is represented by the image data; thus, the temperature described above can be detected based on this image data.

To achieve the object described above, another aspect of the invention refers to a program execution apparatus including a program storage part which stores a program and a program execution part which executes the program. The program execution apparatus further includes the sensing apparatus in any of the above descriptions. The program execution part executes the program by referring to, as a variable, the physical information detected by the detection part of the sensing apparatus.

Consequently, desired physical information is detected based on the image data, thus permitting program execution in accordance with this physical information (inclination or the like). For example, if the subject state change part fitted to the case described above is configured to be replaceable, physical information to be detected can also be changed. That is, a program execution apparatus (game apparatus or the like) which can refer to various types of physical information can be provided with low-cost configuration.

To achieve the object described above, still another aspect of the invention refers to an image taking system including: an image taking part, a case which is fitted with the image taking part, a rotating plate which has an opening and which is fitted to the case so as to be rotatable with an optical axis of an optical system of the image taking part as a central axis, and a mirror which is fixed to the rotating plate and which reflects light from a first subject so that the light enters the image taking part via the opening.

According to the configuration described above, rotating the rotating plate described above permits the photographing direction to be changed while keeping the case fixed, thus improving the usability.

For example, the rotating plate is freely attachable and detachable to and from the case; the rotating plate and a subject state change part which includes a second subject of the image taking part and which, in accordance with an external factor, changes a state of the second subject are selectively fitted to the case in a freely attachable and detachable manner; the image taking system further includes a detection part; and, when the subject state change part is fitted to the case, the detection part detects physical information of a predetermined type which changes in accordance with the external factor based on image data obtained by photographing the second subject.

According to the configuration described above, the image taking part can be used to detect physical information. That is, the image taking system can be provided with a sensing function with low-cost configuration.

As described above, according to the sensing apparatus according to the invention, desired physical information (inclination or the like) can be detected with low-cost configuration.

### BRIEF DESCRIPTION OF THE DRAWINGS

FIGS. 1A and 1B are external views of a game apparatus body according to the embodiments of the present invention;

FIG. 2 is a block diagram showing the electrical configuration of the game apparatus body in FIGS. 1A and 1B and a game cartridge;

FIG. 3 is an internal block diagram of the camera of FIG. 2;

FIG. 4A is an enlarged perspective view of a peripheral part of an attachment according to Example 1 of the invention, and FIG. 4B is a sectional view thereof;

FIGS. 5A and 5B are diagrams for describing the operation of a CPU according to Example 1 of the invention;

FIGS. 6A is an enlarged perspective view showing a modified example of the attachment of FIGS. 4A and 4B, and FIG. 6B is a sectional view thereof;

FIG. 7 is an enlarged perspective view of a peripheral part of an attachment according to Example 2 of the invention;

FIG. 8A is an enlarged perspective view of a peripheral part of an attachment according to Example 3 of the invention, and FIG. 8B is a sectional view thereof;

FIG. 9 is an enlarged perspective view of a peripheral part of an attachment according to Example 4 of the invention;

FIG. 10A is an enlarged perspective view of a peripheral part of an attachment according to Example 5 of the invention, and FIG. 10B is a sectional view thereof;

FIGS. 11A and 11B are diagrams for explaining the operation of a CPU according to Example 5 of the invention;

FIG. 12 is an enlarged perspective view of a peripheral part of an attachment according to Example 6 of the invention;

FIG. 13A is an enlarged perspective view of a peripheral part of an attachment according to Example 7 of the invention, and FIG. 13B is a plan view thereof;

FIG. 14 is an enlarged perspective view of a peripheral part of an attachment according to Example 8 of the invention;

FIG. 15 is an enlarged perspective view of a peripheral part of an attachment according to Example 9 of the invention;

FIG. 16 is an enlarged perspective view of a peripheral part of an attachment according to Example 10 of the invention; and

FIG. 17 is a block diagram showing the electrical configuration of a conventional game apparatus body and a game cartridge.

### DETAILED DESCRIPTION OF PREFERRED EMBODIMENTS

Hereinafter, embodiments of the present invention applied to a mobile game apparatus (hereinafter, abbreviated as “game apparatus”) will be described in detail, with reference to the accompanying drawings. In each of the drawings below, the same portions are provided with the same numerals, and thus overlapping description for the same portions will be basically omitted.

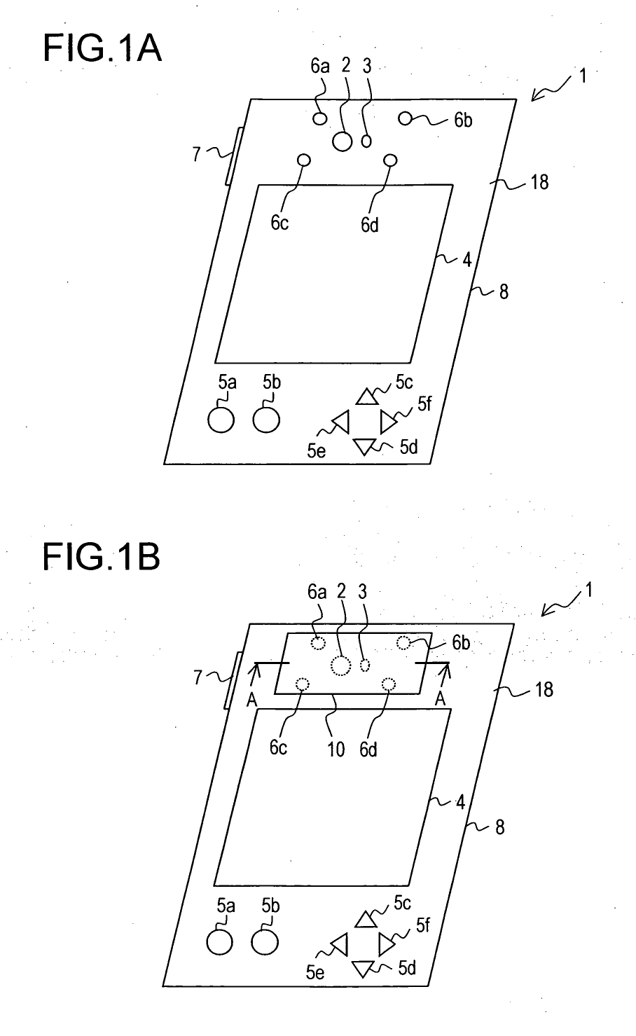

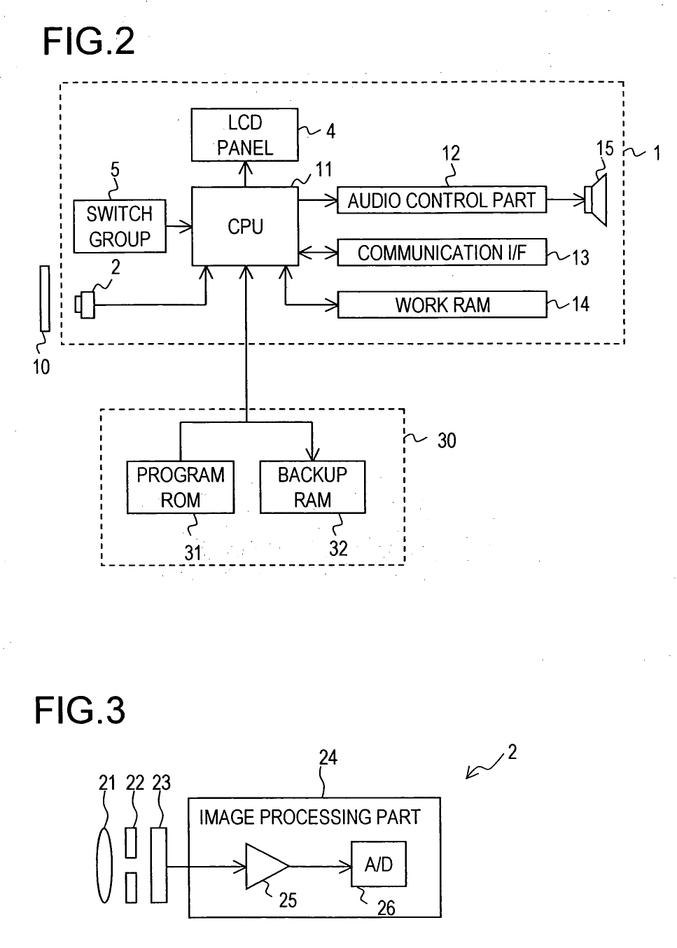

First, the overall configuration of the game apparatus will be described. FIGS. 1A and 1B are each an external view of the game apparatus body 1 according to the embodiments of the invention. FIG. 1A shows an external view of the game apparatus body 1 not fitted with an attachment 10, while FIG. 1B shows an external view of the game apparatus body 1 fitted with the attachment 10. FIG. 2 is a block diagram showing the electrical configuration of the game apparatus body 1 and a game cartridge (hereinafter, abbreviated as “cartridge”) 30. The game apparatus is composed of the game apparatus body 1 and the cartridge 30 freely attachable to and detachable from the game apparatus body 1.

In FIG. 2, the attachment 10 is indicated as being provided outside the game apparatus body 1. The attachment 10 may be considered as being either provided outside the game apparatus body 1 or included in the game apparatus body 1.

The game apparatus body 1 is provided with a case 8 which has a substantially rectangular shape. A camera 2, an LED (Light Emitting Diode) 3, an LCD (Liquid Crystal Display) panel 4, and a switch group 5 composed of switches 5a and 5b, and also 5c, 5d, and 5e, and 5f are all fixed at predetermined positions of the case 8, and also they are all fitted on a top surface 18 side of the case 8. The top surface 18 forms one surface of the case 8 having a substantially rectangular shape and is substantially square-shaped. Moreover, in the case 8, four attachment fitting holes (hereinafter, abbreviated as “fitting hole”) 6a, 6b, 6c, and 6d are provided, also on the top surface 18 side of the case 8. When the cartridge 30 is fitted in a cartridge fitting hole 7 provided in the game apparatus body 1, the game apparatus body 1 and the cartridge 30 are electrically connected to each other.

The attachment 10 is fitted to the case 8 so as to cover the top sides of the camera 2 and LED 3 with the fitting holes 6a to 6d. The attachment 10 is freely attachable to and detachable from the case 8.

The camera 2 is so structured as to include, as shown in FIG. 3, an optical system 21 composed of a plurality of lenses, an aperture stop 22, an image sensor 23, and an image processing part 24.

The image sensor 23 is composed of, for example, a CCD (Charge Coupled Devices), a CMOS (Complementary Metal Oxide Semiconductor) image sensor, or the like. The image sensor 23 photoelectrically converts an optical image entering via the optical system 21 and the aperture stop 22, and transmits to the image processing part 24 an electrical signal obtained by this photoelectric conversion. More specifically, the image sensor 23 is provided with a plurality of pixels (i.e., light-receiving element, not shown) two-dimensionally arrayed in a matrix form. In each photographing, each pixel stores signal charge in amount in accordance with the exposure time. Each pixel sequentially outputs, to the image processing part 24 at the latter stage, an electrical signal having a magnitude proportional to the charge amount of the stored signal charge. For example, the image sensor 23 is a single plate type image sensor for color photographing, which has on the front surface of each pixel thereof a red (R), green (G) or blue (B) color filter (not shown).

The image processing part 24 is so structured as to include: an amplifier circuit 25, an A /D converter (analogue-digital converter) 26, and the like. The amplifier circuit 25 amplifies an analog signal as an output signal of the image sensor 23 with an amplification degree in accordance with so-called auto gain control, and then outputs this signal. The A/D converter 26 sequentially converts output signals of the amplifier circuit 25 into a digital signal. The image processing part 24 subjects, as appropriate, this digital signal to appropriate processing, and outputs image data representing the photographed image.

The image data outputted from the image processing part 24 is composed of pixel data corresponding to each pixel. For example, when the total number of pixels composing the image sensor 23 is 100000, one image data is formed by 100000 pixel data.

Each pixel data is expressed by, for example, an RGB signal composed of a signal R representing the intensity of a red component of received light, a signal G representing the instensity of a green component of the received light, and a signal B representing the instensity of a blue component of the received light. Also, for example, each pixel data is expressed by YUV signals composed of a brightness signal Y representing the brightness of received light and two color signals U and V. The RGB signal and the YUV signals are mutually convertible. For a video signal expressed in the RGB method, the YUV method, or any other method, each pixel data specifies the intensity of a red component, a green component, and a blue component of light received by each pixel, and also specifies the brightness of light received by each pixel.

The image data outputted by the image processing part 24 is provided to a CPU (Central Processing Unit) 11. The camera 2 performs moving image photographing with a predetermined frame rate (for example, 30/second). Therefore, image data representing images photographed in succession are transmitted to the CPU 11 in succession. Moreover, the camera 2 is also capable of performing still image photographing.

The LED 3 irradiates the photographing region of the camera 2, and illuminates when necessary. Switch information specifying the pressed-down state of each of the switches 5a and 5b and so-called a cross-shaped key including the switches 5c, 5d, 5e, and 5f is transmitted to the CPU 11. The CPU 11, based on a game program recorded in a program ROM (Read Only Memory) 31 provided in the cartridge 30 and information specifying game status or the like recorded in a backup RAM (Random Access Memory) 32, provided in the cartridge 30, executes the aforementioned program. Then, the CPU 11, in accordance with this game program, outputs a video signal to the LCD panel 4 and also outputs an audio signal to an audio control part 12.

The LCD panel 4, based on the video signal from the CPU 11, displays an image representing the game contents and the like. The audio output part 12, based on the audio signal from the CPU 11, drives a speaker 15. The speaker 15 outputs the audio signal described above as voice. A communication interface (communication I/F) 13 is an interface which connects a communication cable for communication with a different game apparatus body 1. This communication cable is connected to the communication interface 13 as appropriate. A work RAM 14 is a memory with which the CPU 11 performs data writing and reading as appropriate in the execution of the game program described above. In this work RAM 14 itself, all or part of the game program described above may be temporarily stored.

As described above, the attachment 10 is freely attachable to and detachable from the case 8, and thus any of various types of attachments can be selectively fitted to the case 8. Hereinafter, the operation and the like performed by the game apparatus when various types of attachments are fitted to the case 8 will be described, providing Examples 1 to 10.

In examples 2, 3, 4, 5, 6, 7, 8, 9, and 10, numerals representing an attachment are indicated as 10a, 10b, 10c, 10d, 10e, 10f, 10g, 10h, and 10i, respectively, so that they can be discriminated from one another, and these attachments are each fitted to the case 8 as is the case with the attachment 10 described above. That is, when considering Examples 2, 3, 4, 5, 6, 7, 8, 9, and 10, the “attachment 10” in the above description of the overall configuration is read as attachments 10a, 10b, 10c, 10d, 10e, 10f, 10g, 10h, and 10i, respectively.

### EXAMPLE 1

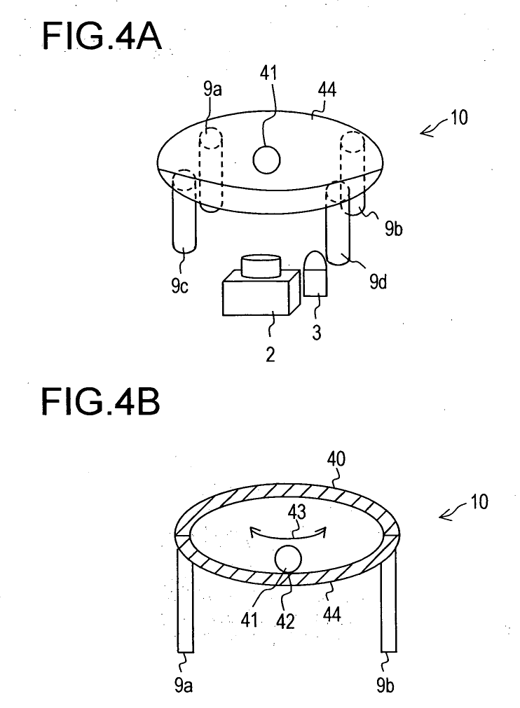

First, Example 1 will be described. In Example 1, the attachment 10 is fitted to the case 8. FIG. 4A is an enlarged perspective view of the peripheral portion of the attachment 10 with the upper plate 40 removed. FIG. 4B is a sectional view of the attachment 10, taken along line A-A of FIG. 1B. Note that the case 8 is omitted and thus not shown in FIG. 4A, and that the camera 2, the LED 3, and the case 8 are omitted and thus not shown in FIG. 4B.

The attachment 10 is so structured as to have: fitting rods 9a, 9b, 9c, and 9d which fit with fitting holes 6a, 6b, 6c, and 6d, respectively; an upper plate 40; a lower plate 44; and a globe 41 of a spherical shape as a moving body. The fitting rods 9a, 9b, 9c, and 9d are formed of, for example, resin material.

The lower plate 44 has a shape of a rotational parabolic curve with a cross section drawing a parabolic curve, like a reflecting mirror of a parabolic antenna. On the concave surface of the lower plate 44, the globe 41 is arranged. When the case 8 is held so that a top surface 18 of the case 8 is oriented parallel to the horizontal plane (where the inclination of the case 8 in this case is 0°), the lower plate 44 is fixed at a peripheral part thereof to the fitting rods 9a, 9b, 9c, and 9d so that the globe 41 is located at a lowermost point (point on the side closest to the ground) 42 of the surface on which the lower plate 44 and the globe 41 make contact with each other. When the inclination of the case 8 is 0°, the globe 41 makes contact with the lower plate 44 at the lowermost point 42. When the case 8 is inclined with a line on the top surface 18 as a central axis (inclined in the vertical direction), that is, when the inclination of the case 8 becomes not equal to 0° by a force of operation made by the user (by an external force), the globe 41 moves on the lower plate 44 in the direction of an arrow 43 by gravity force.

The upper plate 40 is jointed at the peripheral part thereof with the lower plate 44 in such a manner that the globe 41 does not protrude from a region where it makes contact with the lower plate 44 when the case 8 is inclined.

The camera 2 performs moving image photographing, targeting the globe 41 as a main subject from the bottom side of the lower plate (case 8 side) so that the entire lower plate 44 falls within the photographing region. The camera 2 and the attachment 10 are arranged so that the lowermost point 42 and the center of the photographing region substantially agree with each other. The LED 3 irradiates the bottom surface side of the lower plate 44 with light so as to illuminate the photographing region of the camera 2.

The upper plate 40, the lower plate 44, and the globe 41 are formed of, for example, resin material. In order to permit the camera 2 to capture the globe 41 as a subject as clearly as possible, for example, the colors of the lower plate 44 and the globe 41 are thin white and pink, respectively, while the upper plate 40 is transparent. Providing the lower plate 44 that is thin white blocks (diffuses) incidence light representing the outside scene and thus can prevent a phenomenon that the subject (the globe 41 in this example) to be originally captured is buried in the outside scene in the photographing by the camera 2. Providing the globe 41 that is pink results in that the portion where the globe 41 and the lower plate 44 make contact with each other looks pink as viewed from the camera 2 side. The upper plate 40 that is transparent is provided for the purpose of obtaining the interior light or the sun light to thereby brighten the photographing region.

The color combination described above is provided as one example, and any color can be adopted as long as the portion where the globe 41 and the lower plate 44 make contact with each other (or the globe 41 itself) is discriminated from the outside scene by the camera 2 . For example, the lower plate 44 may be arbitrarily half transparent in color, while the globe 41 may be arbitrarily opaque in color. Moreover, the upper plate 40 may be half transparent or opaque in color.

Image data transmitted in succession from the image processing part 24 includes information specifying the position and movement of the globe 41 in the photographing region. Moreover, the position and movement of the globe 41 permits specifying the degree of the inclination of the case 8 and its change. Using this information, the CPU 11 detects the position and movement of the globe 41 in the photographing region based on the image data from the image processing part 24, and detects the degree of inclination of the case 8 and its change based on the detected position and movement.

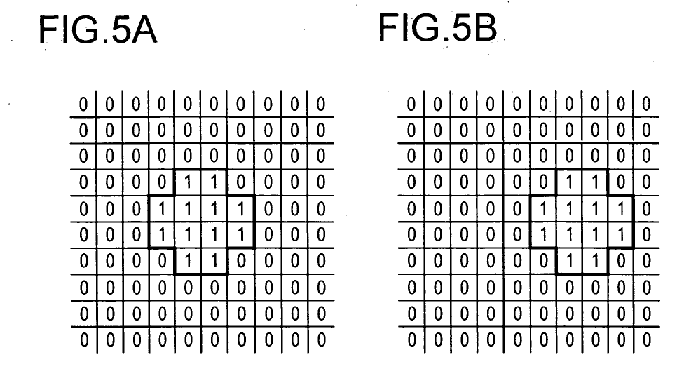

For example, the intensity of a signal R (a red component of light received by each pixel) of each pixel data is binarized with a predetermined threshold value. When the inclination is 0°, as shown in FIG. 5A, only a portion corresponding to the pixels located at the center of the image taking surface of the image sensor 23 is “1”, while other portions are “0”. When the case 8 is inclined (when the inclination is not 0°), as shown in FIG. 5B, the pixels close to the peripheral part of the image taking surface provides “1” by way of the binarization described above. Specifying the pixels providing “1” by way of this binarization permits detection of the position of the globe 41 in the photographing region, and investigating a change in the pixels providing “1” by using successive image data permits detection of the movement (the speed of movement, direction of movement, acceleration of movement, or the like) of the globe 41 in the photographing region.

Due to a difference in the brightness on the image between the portion where the globe 41 and the lower plate 44 make contact with each other (and near this portion) and a portion where they do not make contact with each other, the intensity of a brightness signal Y corresponding to each pixel data may be binarized with a predetermined threshold value. Also in this case, a difference in the inclination of the case 8 provides a difference in the binarized information as shown in FIGS. 5A and 5B, thereby permitting detection of the position of the globe 41 and its change.

Providing a function, table data, or the like representing the relationship between the position of the globe 41 in the photographing region and the degree of inclination of the case 8 permits the CPU 11 to detect the degree of inclination of the case 8 and also obtain its change by calculation. In this manner, the attachment 10 achieves the function of an inclination sensor.

The CPU 11, upon execution of the game program described above, treats data representing the detected degree of inclination of the case 8 and its change (the position of the globe 41 in the photographing region and its change) as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

For example, the attachment 10 is used for a balance game or the like in which a ball on the game moves horizontally in accordance with the inclination of the case 8. Moreover, when the case 8 is oscillated in the horizontal direction, the game status may change in accordance with the width and speed of this oscillation. Replacement of operation by use of the cross-shaped key (the switches 5c to 5f of FIGS. 1A and 1B) with the operation of the inclination of the case 8 in this manner increases variation of plays provided by the game apparatus. Needless to say, the operation by use of the cross-shaped key may be additionally used in combination to achieve more complicated operation.

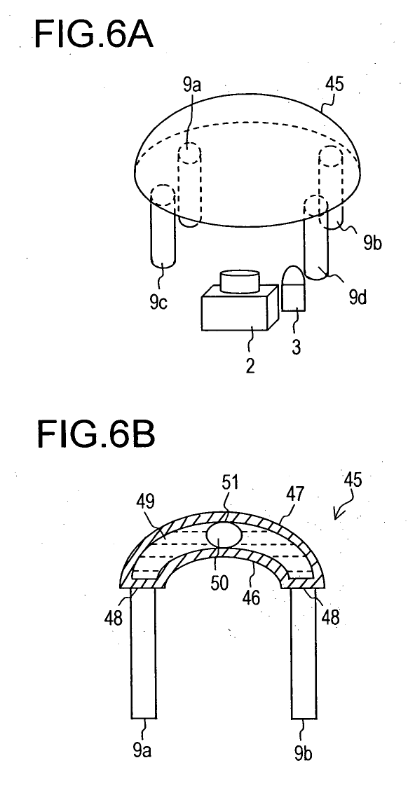

Moreover, instead of the lower plate 44, the upper plate 40, and the globe 41 of FIGS. 4A and 4B, a dome body 45 as shown in FIGS. 6A and 6B may be provided. FIG. 6A is an enlarged perspective view of the peripheral portion of the dome body 45, and FIG. 6B is a sectional view of an attachment formed of a dome body 45, taken along line A-A of FIG. 1B. Note that the case 8 is omitted and thus not shown in FIG. 6A, and that the camera 2, the LED 3, and the case 8 are omitted and thus not shown in FIG. 6B.

The dome body 45 is so structured as to have: a dome lower plate 46 which has a shape of a rotational parabolic curve with a cross section drawing a parabolic curve, like a reflecting mirror of a parabolic antenna; a dome upper plate 47 having a shape of a rotational parabolic curve with a cross section drawing a parabolic curve in the same manner as the dome lower plate 46; and a coupling part 48 of a ring shape which couples together the dome lower plate 46 and the dome upper plate 47. In the closed space formed by the dome lower plate 46, the dome upper plate 47, and the coupling part 48, a liquid 49, such as water or the like, is injected with a bubble 50 mixed therewith. The colors of the dome upper plate 47 and the liquid 49 are thin white and pink, respectively, while the dome lower plate 46 is transparent.

When the inclination of the case 8 is 0°, the dome body 45 is fixed at the peripheral part thereof with the fitting rods 9a, 9b, 9c, and 9d so that the bubble 50 is located at an uppermost point 51 on the surface where the dome upper plate 47 and the bubble 50 make contact with each other. When the case 8 is inclined with the line on the top surface 18 as a central axis (when it is included in the vertical direction), the bubble 50 moves along the convex surface of the dome upper plate 47 by gravity force.

The camera 2 performs moving image photographing (or still image photographing), targeting the bubble 50 as a main subject from the bottom side of the dome lower plate 46 (the case 8 side) so that the entire dome upper plate 47 falls within the photographing region. The camera 2 and the dome body 45 provided with an attachment are arranged so that the uppermost point 51 and the center of the photographing region substantially agree with each other. The LED 3 irradiates the bottom surface side of the dome lower plate 46 with light so as to illuminate the photographing region of the camera 2.

Image data transmitted in succession from the image processing part 24 includes information specifying the position and movement of the bubble 50 in the photographing region. Moreover, the position and movement of the bubble 50 permits specifying the degree of inclination of the case 8 and its change. Using this information, the CPU 11 detects the position and movement of the bubble 50 in the photographing region based on the image data from the image processing part 24, and detects the degree of inclination of the case 8 and its change based on the detected position and movement. The contents of processing performed by the CPU 11 upon this detection is the same as the processing performed in the case where the globe 41 is used.

The dome lower plate 46 may be provided as a flat surface which is parallel to the top surface 18 of the case 8. In this case, the dome lower plate forms a flat surface together with the coupling part 48.

The example where both the position and movement of the globe 41 (or the bubble 50) in the photographing region are detected has been provided above, but if one of them is not required, only the position or only the movement may be detected.

### EXAMPLE 2

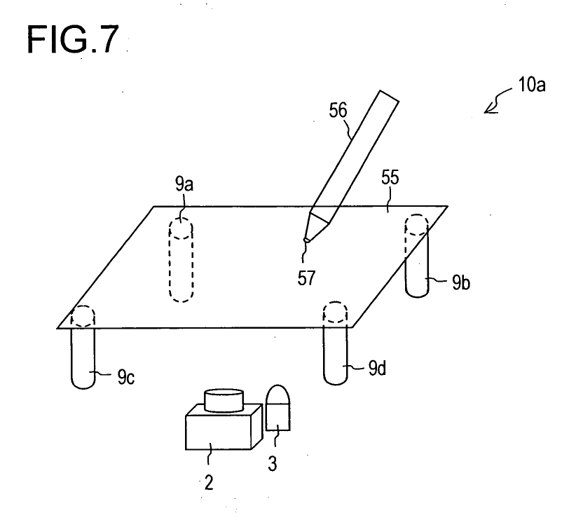

Next, Example 2 will be described. In Example 2, the attachment 10a is fitted to the case 8. FIG. 7 is an enlarged perspective view of the peripheral portion of the attachment 10a. Note that the case 8 is omitted and thus not shown in FIG. 7.

The attachment 10a is so structured as to have: fitting rods 9a, 9b, 9c, and 9d; and a drawing surface 55. The drawing surface 55 is a plate-like body having a square shape as viewed from above, and fixed at the peripheral part thereof to the fitting rods 9a, 9b, 9c, and 9d. The drawing surface 55 and the top surface 18 of the case 8 are substantially parallel to each other. A game apparatus of Example 2 has a pen 56 of a rod-like shape which is used simultaneously with the attachment 10a. One end of the pen 56 is provided with a pen tip 57. To use the pen 56, the user brings the pen tip 57 into contact with an arbitrary point on an upper surface (on the side opposite to the case 8) of the drawing surface 55.

The camera 2 performs moving image photographing (or still image photographing), targeting the pen tip 57 as a main subject from the bottom side (case 8 side) of the drawing surface 55 so that the entire drawing surface 55 falls within the photographing region. The camera 2 and the attachment 10a are arranged so that the center of the drawing surface 55 (intersection between diagonal lines of the square formed by the drawing surface 55 as viewed from above) and the center of the photographing region substantially agree with each other. The LED 3 irradiates the bottom surface side of the drawing surface 55 with light so as to illuminate the photographing region of the camera 2.

The drawing surface 55 and the pen 56 are formed of, for example, resin material. In order to permit the camera 2 to capture the pen tip 57 as a subject as clearly as possible, for example, the colors of the drawing surface 55 and the pen tip 57 are thin white and pink, respectively, for the same reason as that described in Example 1.

The color combination described above is provided as one example, and any color can be adopted as long as the portion where the pen tip 57 and the drawing surface 55 make contact with each other is discriminated from the outside scene by the camera 2. For example, the drawing surface 55 may be arbitrarily half transparent in color, while the pen tip 57 may be arbitrarily opaque in color.

Image data transmitted in succession from the image processing part 24 includes information specifying the position and movement of the pen tip 57 in the photographing region. The CPU 11 detects the position and movement of the pen tip 57 in the photographing region based on the image data from the image processing part 24.

For example, the position of the pen tip 57 in the photographing region is specified by binarizing the intensity of a signal R (a red component of light received by each pixel) of each pixel data with a predetermined threshold value and then specifying a pixel that provides an intensity equal to or larger than this threshold value. Investigating, by using the successive image data, a change in a pixel providing an intensity equal to or larger than the threshold value permits detection of the movement (the speed of movement, direction of movement, acceleration of movement, or the like) of the pen tip 57 in the photographing region. Moreover, as described in Example 1, the position and movement of the pen tip 57 may be detected based on a brightness signal Y of each pixel data.

The CPU 11, upon execution of the game program described above, treats data representing the detected position and movement of the pen tip 57 as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

For example, the game apparatus provided with the attachment 10a achieves a drawing function (drawing software function) of causing the LCD panel 4 to display a diagram similar to the movement locus of the pen tip 57 on the drawing surface 55. In this function, by bringing the pen tip 57 into contact with a specific portion on the upper surface (on the side opposite to the case 8) of the drawing surface 55, the color of the diagram displayed on the LCD panel 4 can be changed (color change function), and also the diagram display on the LCD panel 4 can be erased (erasing function). Replacement of operation by use of the cross-shaped key (the switches 5c to 5f of FIGS. 1A and 1B) with the operation performed for the pen 56 in this manner increases variation of plays provided by the game apparatus.

By using an LED or the like, the pen tip 57 may be adapted to be self-emitting. Moreover, the pen 56 may be configured so that the pen tip 57 generates a plurality of colors by, for example, using a plurality of LEDs. In this case, the CPU 11 changes the color of the diagram displayed on the LCD panel 4 in accordance with the color generated by the pen tip 57. Furthermore, by using a plurality of pens with pen tips of different colors, the position and movement of the plurality of pen tips may be reflected on the execution of a game program (a plurality of users operate the game apparatus).

The example where both the position and movement of the pen tip 57 in the photographing region are detected has been provided above, but if one of them is not required, only the position or only the movement may be detected.

### EXAMPLE 3

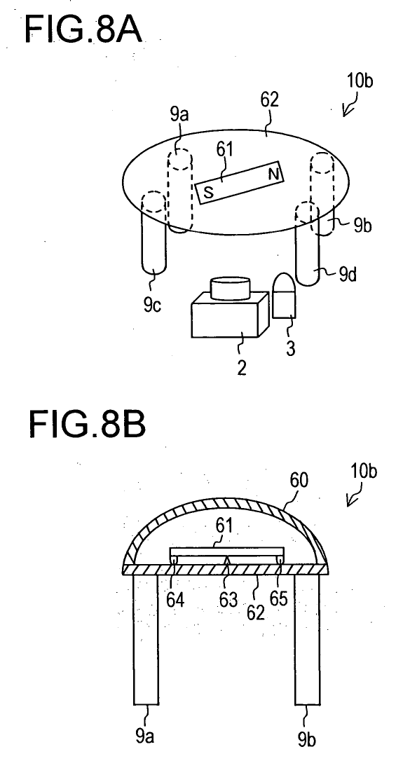

Next, Example 3 will be described. In Example 3, the attachment 10b is fitted to the case 8. FIG. 8A is an enlarged perspective view of the peripheral portion of the attachment 10b with an upper plate 60 removed. FIG. 8B is a sectional view of the attachment 10b, taken along line A-A of FIG. 1B. Note that the case 8 is omitted and thus not shown in FIG. 8A, and that the camera 2, the LED 3, and the case 8 are omitted and thus not shown in FIG. 8B. Also note that the line A-A does not extend across a magnet 61.

The attachment 10b is so structured as to have: fitting rods 9a, 9b, 9c, and 9d; the upper plate 60; the magnet 61; and a lower plate 62.

The lower plate 62 is a discoid plate having a shape of a circle as viewed from above. At the center of the surface of the lower plate 62 on the side opposite to the case 8, a magnet support part 63 is formed in a protruding manner. The magnet 61 is a compass having a square shape as viewed from above, and is arranged above the lower plate 62 so that the center of one surface of this compass makes contact with the magnet support part 63. The magnet 61 is rotatable with the magnet support part 63 as a supporting point, in accordance with the direction of a magnetic force generated by earth magnetism (magnetic field). At the end part corresponding to the S pole of the magnet 61, a protruding part 64 is provided, while at the end part corresponding to the N pole of the magnet 61, a protruding part 65 is provided. Each end surface of the protruding parts 64 and 65 is in contact with the top surface of the lower plate 62 (surface on the side opposite to the case 8). The rotation of the magnet 61 described above is achieved while involving contact between the protruding parts 64, 65 and the top surface of the lower plate 62.

The upper plate 60 is a plate of a dorm-like shape, which is provided for the purpose of protection of the magnet 61 or the like, and is joined at the peripheral part thereof with the lower plate 62.

The camera 2 performs moving image photographing (or still image photographing), targeting the magnet 61 (the protruding parts 64 and/or 65 of the magnet 61) as a main subject from the bottom side of the lower plate 62 (case 8 side) so that the entire lower plate 62 or the entire magnet 61 falls within the photographing region. The camera 2 and the attachment 10b arranged so that the magnet supporting part 63 is located at the center of the photographing region. The LED 3 irradiates the bottom surface side of the lower plate 62 with light so as to illuminate the photographing region of the camera 2.

The upper plate 60 and the lower plate 62 are formed of, for example, resin material. In order to permit the camera 2 to capture the magnet 61 (the protruding parts 64 and/or 65 of the magnet 61) as a subject as clearly as possible, for example, the color of the lower plate 62 is thin white, the colors of the protruding parts 64 and 65 are pink and green, respectively, and the upper plate 60 is transparent, for the same reason as that described in Example 1.

The color combination described above is provided as one example, and any color can be adopted as long as the portion where the protruding part 64 (and/or the protruding part 65) of the magnet 61 and the lower plate 62 make contact with each other is discriminated from the outside scene by the camera 2. For example, the lower plate 62 may be arbitrarily half transparent in color, while the protruding part 64 (and/or the protruding part 65) may be arbitrarily opaque in color.

Image data transmitted in succession from the image processing part 24 includes information specifying the position of the protruding part 64 (and/or the protruding part 65) in the photographing region. Moreover, the position of the protruding part 64 (and/or the protruding part 65) permits specifying the orientation of the case 8. Using this information, the CPU 11 detects the position of the protruding part 64 (and/or the protruding part 65) in the photographing region based on the image data from the image processing part 24, and detects the orientation of the case 8 based on the detected position.

For example, the position of the protruding part 64 in the photographing region is specified by binarizing the intensity of a signal R (a red component of light received by each pixel) of each pixel data with a predetermined threshold value and then specifying a pixel that provides an intensity equal to or larger than this threshold value. Moreover, as described in Example 1, the position of the protruding part 64 (and/or the protruding part 65) may be detected based on a brightness signal Y of each pixel data.

Providing a function, table data, or the like representing the relationship between the position of the protruding part 64 (and/or the protruding part 65) in the photographing region and the orientation of the case 8 permits the CPU 11 to detect the orientation of the case 8, that is, the direction of a magnetic force generated by earth magnetism (magnetic field). In this manner, the attachment 10b achieves the function of a magnetic sensor.

The CPU 11, upon execution of the game program described above, treats data representing the detected orientation of the case 8 (direction of a magnetic force) as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

For example, the attachment 10b is used for a navigation game, an orientation game, and the like which use map information or the like. In these games, in accordance with the orientation of the case 8 relative to the direction of the magnetic force generated by earth magnetism, the screen on the game (the display screen of the LCD panel 4 or the like) or progress of the game is changed.

### EXAMPLE 4

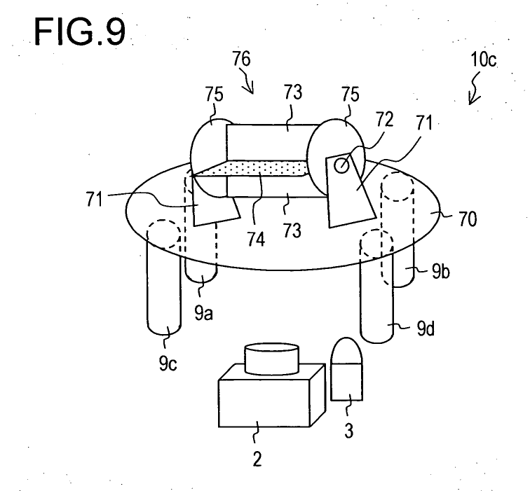

Next, Example 4 will be described. In Example 4, the attachment 10c is fitted to the case 8. FIG. 9 is an enlarged perspective view of the peripheral portion of the attachment 10c. Note that the case 8 is omitted and thus not shown in FIG. 9.

The attachment 10c is so structured as to have: fitting rods 9a, 9b, 9c, and 9d; a support plate 70; and a windmill 76 fixed on the support plate 70. The support plate 70 is a plate-like body having a circular shape as viewed from above, and fixed at the peripheral part thereof to the fitting rods 9a, 9b, 9c, and 9d. The circular-shaped surface of the support plate 70 and the top surface 18 of the case 8 are substantially parallel to each other.

The windmill 76 is so structured as to have: two support bases 71 which are fixed on the support plate 70 in such a manner as to be orthogonal thereto; a support rod 72 of a rod-like shape which is so fixed as to be inserted in a hole provided in each of the support bases 71 and which is parallel in the long-axis direction thereof to the circular-shaped surface of the support plate 70; and blades 73 and 74 which are fixed to the support rod 72 and which are so fitted as to be rotatable with the support rod 72 as their rotation axis; two blade support parts 75 of a circular shape which are fixed to the support rod 72 so as to sandwich the blades 73 and 74 and which rotate together with the blades 73 and 74. The numbers of each of the blades 73 and 74 provided is two (one of the blades 74 is not shown in FIG. 9).

The total four blades 73 and 74 have the same rectangular shape. The cross section of the total four blades 73 and 74, each with one side thereof fixed to the support rod 72 and along the direction orthogonal to the long-axis direction of the support rod 72, is cross-shaped.

The camera 2 performs moving image photographing (or still image photographing), targeting the total four blades 73 and 74 as main subjects from the bottom side of the support plate 70 (case 8 side) so that the entire support plate 70 or the total four blades 73 and 74 fall within a photographing region. The camera 2 and the attachment 10c are arranged so as to permit such moving image photographing. The LED 3 irradiates the bottom surface side of the support plate 70 with light so as to illuminate the photographing region of the camera 2. When the blades 73 and 74 of the windmill 76 are rotated by an external force, such as a force of wind or human power, the condition of this rotation is photographed by the camera 2.

The support plate 70 and the windmill 76 are formed of, for example, resin material. For example, the color of the support plate 70 is transparent or thin white, while the colors of the blades 73 and 74 are pink and green, respectively. The color combination described above is provided as one example, and any color can be adopted as long as the rotation condition of the blades 73 and 74 is discriminated from the outside scene by the camera 2. For example, the support plate 70 may be arbitrarily half transparent, while the blades 73 and 74 may be arbitrarily opaque in color different from each other.

Image data transmitted in succession from the image processing part 24 includes information specifying the rotation condition of the blades 73 and 74. The CPU 11 detects the rotation condition of the blades 73 and 74 based on the image data from the image processing part 24. In this manner, the attachment 10c achieves the function of a rotation sensor (rotating meter).

For example, focus on a pixel receiving light from a region through which each of the blades 73 and 74 pass during their rotation (this focused pixel is hereinafter referred to as a focused pixel). The passage through the region described above by the pink blade 73 and the passage through the region described above by the green blade 74 can be detected by binarizing the intensity of a signal R (red component of light received) and the intensity of a signal G (green component of light received) of pixel data of the focused pixel with respective predetermined threshold values and then referring to the binarized data. The use of successive image data permits detection of rotation speed, the total number of rotations, and the like of the windmill 76 composed of the four blades. Moreover, following the rotation of the blades 73 and 74, the intensity of a brightness signal Y in the pixel data of the focused pixel also fluctuates. Thus, referring to this fluctuation also permits detection of the rotation speed, the total number of rotations, and the like of the windmill 76.

The CPU 11, upon execution of the game program described above, treats data representing the detected rotation condition of the blades 73 and 74 (or the rotation speed or the like of the windmill 76 detected based on this condition) as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

For example, the attachment 10c is used for a yacht game or the like in which the yacht navigation speed on the game changes in accordance with the rotation speed of the windmill 76.

### EXAMPLE 5

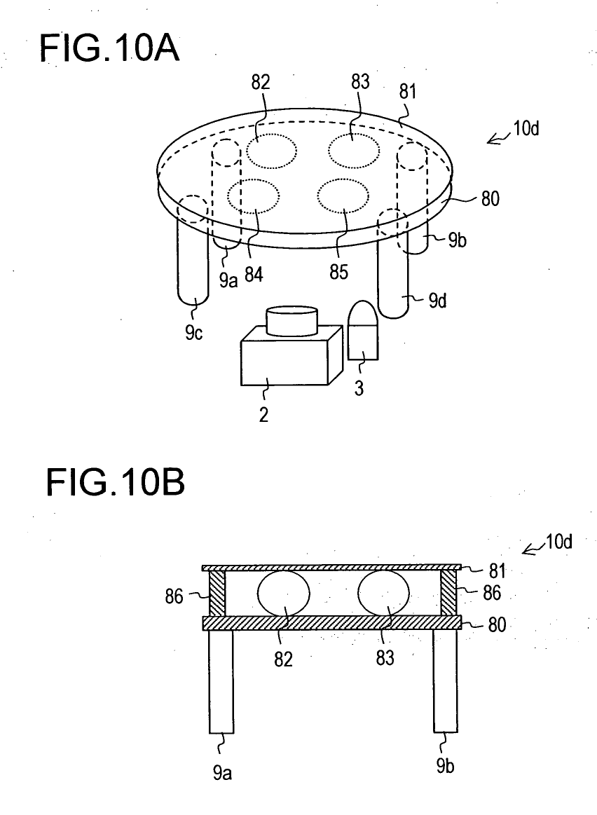

Next, Example 5 will be described. In Example 5, the attachment 10d is fitted to the case 8. FIG. 10A is an enlarged perspective view of the peripheral portion of the attachment 10d. FIG. 10B is a sectional view of the attachment 10d, taken along line A-A of FIG. 1B. Note that the case 8 is omitted and thus not shown in FIG. 10A, and that the camera 2, the LED 3, and the case 8 are omitted and thus not shown in FIG. 10B. Also note that line A-A passes between elastic bodies 82 and 84 and between elastic bodies 83 and 85.

The attachment 10d is so structured as to have: fitting rods 9a, 9b, 9c, and 9d; a lower plate 80; an upper plate 81; elastic bodies 82, 83, 84, and 85; and a joint 86 (not shown in FIG. 10A). The lower plate 80 is a plate-like body having a circular shape as viewed from above, and has rigidity. The upper plate 81 has a circular shape as viewed from above, and is provided in the form of, for example, a sheet having flexibility. The lower plate 80 is fixed at the peripheral part thereof to the fitting rods 9a, 9b, 9c and 9d. The joint 86 has the shape of a cylinder, with one end surface thereof joined with the lower plate 80 and with the other end surface thereof joined with the upper plate 81 so that the circular-shaped surface of the lower plate 80 and the circular-shaped surface of the upper plate 81 become substantially parallel to the top surface 18 of the case 8.

The elastic bodies (pressure deformable bodies) 82 to 85 are arranged in the closed space formed by the lower plate 80, the upper plate 81, and the joint 86. The elastic bodies 82 to 85 are placed respectively at mutually different positions on the top surface of the lower plate 80 (on the side opposite to the case 8). The elastic bodies 82 to 85 are placed at the four points equidistant from the center of the circular body of the lower plate 80 as viewed from above.

The elastic bodies 82 to 85 are spherical rubbers. Each of the elastic bodies 82 to 85 is sandwiched vertically from the bottom and the top by the lower plate 80 and the upper plate 81, and is in point or surface contact with the lower plate 80 and the upper plate 81.

The camera 2 performs moving image photographing (or still image photographing), targeting the elastic bodies 82 to 85 (more specifically, the contact portion between the elastic bodies 82 to 85 and the lower plate 80) as main subjects from the bottom side (case 8 side) of the lower plate 80 so that the entire lower plate 80 or the entire portion where the lower plate 80 makes contact with the elastic bodies 82 to 85 falls within the photographing region. The camera 2 and the attachment 10d are arranged so that the center of the circular body of the lower plate 80 substantially agree with the center of the photographing region as viewed from above. The LED 3 irradiates the bottom surface side of the lower plate 80 with light so as to illuminate the photographing region of the camera 2.

The lower plate 80 and the upper plate 81 are formed of, for example, resin material. When a pressure is applied to the upper plate 81 from above through operation by the user or the like, the upper plate 81 is bent toward the lower plate 80, and in accordance with this bending (pressure), the elastic bodies 82 to 85 deform so that the vertical thickness thereof becomes smaller. In this condition, the contact area between each of the elastic bodies 82 to 85 and the lower plate 80 changes in accordance with the magnitude of this pressure applied and the position of the upper plate 81 where the pressure is applied.

In order to permit the camera 2 to capture the contact portion between each of the elastic bodies 82 to 85 and the lower plate 80 as clearly as possible, for example, the color of the lower plate 80 is thin white, the colors of the elastic bodies 82 to 85 are pink, and the upper plate 81 is transparent, for the same reason as that described in Example 1. The color combination described above is provided as one example, and any color can be adopted as long as the contact portion between each of the elastic bodies 82 to 85 and the lower plate 80 is discriminated from the outside scene by the camera 2. For example, the lower plate 80 may be arbitrarily half transparent in color, while the elastic bodies 82 to 85 may be arbitrarily opaque in color. Moreover, the colors of the elastic bodies 82 to 85 may be different from each other, and the upper plate 81 may be half-transparent or opaque in color.

Image data transmitted in succession from the image processing part 24 includes information specifying the contact area between the each of the elastic bodies 82 to 85 and the lower plate 80. Moreover, there is correlation between each contact area and the magnitude of pressure applied to the upper plate 81 as well as the position on the upper plate 81 where this pressure is applied. Using this information, the CPU 11 detects each contact area based on the image data from the image processing part 24, and detects, based on the detected each contact area, the magnitude of pressure applied to the upper plate 81 and the position on the upper plate 81 where this pressure is applied.

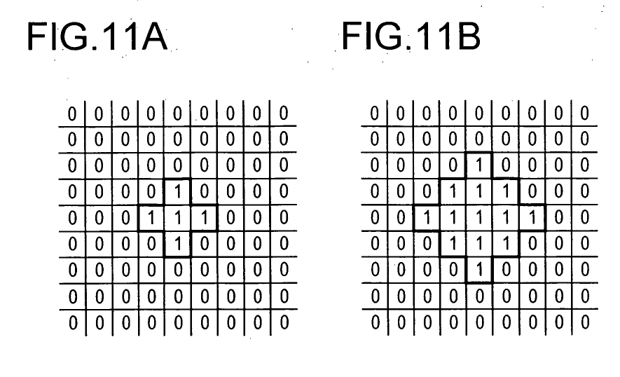

Focusing on the elastic body 82, one example of a detection method will be described below. For example, the intensity of a signal R of each pixel data (a red component of light received by each pixel) is binarized with a predetermined threshold value. If the pressure applied to the elastic body 82 via the upper plate 81 is relatively small, the contact area between the elastic body 82 and the lower plate 80 is relatively small. Thus, the region viewed as pink from the camera 2 side is relatively narrow, as shown in FIG. 11A, for example, only binarized data corresponding to five pixels is equal to “1”. On the other hand, if the pressure applied to the elastic body 82 via the upper plate 81 is relatively large, the contact area between the elastic body 82 and the lower plate 80 is relatively large. Thus, the region viewed as pink from the camera 2 side is relatively large, as shown in FIG. 11B, for example, and binarized data corresponding to thirteen pixels is equal to “1”.

The CPU 11 can detect the contact area between the elastic body 82 and the lower plate 80 by counting the number of pixels providing “1” in the binarized data. The detection can be done similarly for the contact area between each of the elastic bodies 83 to 85 and the lower plate 80.

Due to a difference in the brightness on the image between the portion where each of the elastic bodies 82 to 85 and the lower plate 80 make contact with other (and its periphery) and the portion where they do not make contact with each other, the intensity of a brightness signal Y corresponding to each pixel data may be binarized with a predetermined threshold value. Also in this case, a difference in the magnitude of pressure applied to the elastic bodies 82 to 85 results in a difference in the binarized data as shown in FIGS. 11A and 11B, thus permitting detection of the contact area between each of the elastic bodies 82 to 85 and the lower plate 80.

For example, when a pressure is applied from immediately above the elastic body 82, an increase in the contact area between the elastic body 82 and the lower plate 80 is relatively large, while an increase in the contact area between the elastic body 85 and the lower plate 80 is relatively small. Thus, based on the ratio in the contact area between each of the elastic bodies 82 to 85 and the lower plate 80, the position where the pressure applied can be detected.

Providing a function, table data, or the like representing the relationship among the contact area between each of the elastic bodies 82 to 85 and the lower plate 80 and the magnitude of pressure applied as well as the position where the pressure has been applied permits outputting the magnitude of pressure or the like as a numerical value. In this manner, the attachment 10d achieves the function of a pressure sensor.

The CPU 11, upon execution of the game program described above, treats data representing the detected magnitude of pressure and position where the pressure has been applied (the contact area between each of the elastic bodies 82 to 85 and the lower plate 80) as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

The attachment 10d is used for, for example, a music game and the like, in which pseudo musical instrument performance can be experienced by pressure application to the upper plate 81. In such a music game, the sound volume can be changed in accordance with the magnitude of the pressure, and the type of a musical instrument can be changed in accordance with the position where the pressure is applied, thereby increasing variation of plays provided by the game apparatus.

The example where the four elastic bodies 82 to 85 are provided as an elastic body has been provided above, but needless to say, the number of elastic bodies is not limited to “4”. If only the magnitude of pressure is to be detected, one elastic body may be arranged at the center of the circular lower plate 80 as viewed from above.

Moreover, the example where both the magnitude of pressure applied to the upper plate 81 (each of the elastic bodies 82 to 85) and the position on the upper plate 81 where this pressure has been applied are detected has been provided above, but if one of them is not required, only the magnitude of the pressure or only the position on the upper plate 81 where the pressure has been applied may be detected.

### EXAMPLE 6

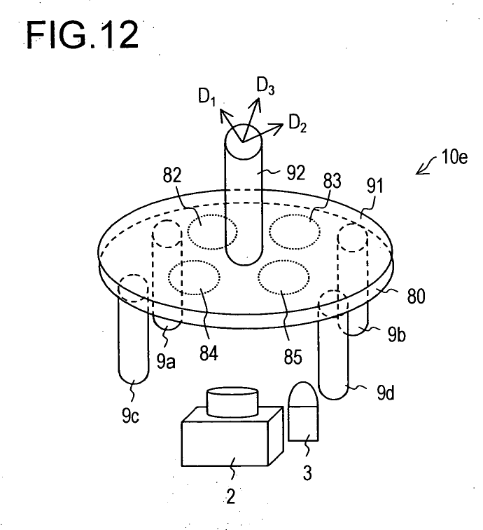

Next, Example 6 will be described. In Example 6, the attachment 10e is fitted to the case 8. FIG. 12 is an enlarged perspective view of the peripheral portion of the attachment 10e. Note that the case 8 is omitted and thus not shown in FIG. 12.

The attachment 10e is so structured as to have: fitting rods 9a, 9b, 9c, and 9d; a lower plate 80; an upper plate 91; elastic bodies 82, 83, 84, and 85; a joint 86 (not shown in FIG. 12); and an joystick 92. More specifically, the attachment 10e is provided by replacing the upper plate 81 included in the attachment 10d shown in FIGS. 10A and 10B with the upper plate 91 and then adding the joystick 92 thereon.

The lower plate 80 is a plate-like body having a circular shape as viewed from above, and has rigidity. The upper plate 91 is a plate-like body having an outer shape of a circle as viewed from above, and with the center of this circle, the joystick 92 is joined via a coupling mechanism part, not shown. The upper plate 91 may be provided in the form of a sheet having flexibility, as is the case with the upper plate 81 in Example 5. The joystick 92 is a rod-like body forming a substantially columnar shape. With no external force applied to the joystick 92, the longitudinal direction (central axis) of the joystick 92 is orthogonal to the circular surface of the upper plate 91 as viewed from above. The upper plate 91 is, for example, transparent in color (it may be half-transparent or opaque in color).

The lower plate 80 is fixed at the peripheral part thereof to the fitting rods 9a, 9b, 9c and 9d. As shown in FIG. 10B, the joint 86 (not shown in FIG. 12) has the shape of a cylinder, with one end surface thereof joined with the lower plate 80 and with the other end surface thereof joined with the upper plate 91 so that the circular-shaped surface of the lower plate 80 and the circular-shaped surface of the upper plate 91 become substantially parallel to the top surface 18 of the case 8.

The elastic bodies (pressure deformable bodies) 82 to 85 are arranged in the closed space formed by the lower plate 80, the upper plate 91, and the joint 86. The arrangement relationship between the elastic bodies 82 to 85 and the lower plate 80 is the same as that described in Example 5. Each of the elastic bodies 82 to 85 is sandwiched from the bottom and the top by the lower plate 80 and the upper plate 91, and is in point or surface contact with the lower plate 80 and the upper plate 91.

The camera 2 performs moving image photographing (or still image photographing), targeting the elastic bodies 82 to 85 (more specifically, the contact portion between the elastic bodies 82 to 85 and the lower plate 80) as main subjects from the bottom side (case 8 side) of the lower plate 80 so that the entire lower plate 80 or an entire portion where the lower plate 80 and the elastic bodies 82 to 85 make contact with each other falls within the photographing region. The camera 2 and the attachment 10e are arranged so that the center of the circular body of the lower plate 80 substantially agree with the center of the photographing region as viewed from above. The LED 3 irradiates the bottom surface side of the lower plate 80 with light so as to illuminate the photographing region of the camera 2.

Applying to the joystick 92 a force that tilts the longitudinal axis of the joystick 92 toward the top surface of the upper plate 91 converts this force into a force that presses the upper plate 91 from above via the coupling mechanism part, not shown, so that pressure in accordance with the magnitude and direction of this tilting force is applied to the elastic bodies 82 to 85 from above via the upper plate 91.

For example, when a force tilting the joystick 92 is applied in the direction (direction D₁ in FIG. 12) toward the area where elastic body 82 is arranged, pressure having a strength in accordance with the magnitude of this force is applied to the elastic body 82 from the above (from the upper plate 91 side), while no pressure is applied to the elastic bodies 83 to 85. In this case, the contact area between the elastic body 82 and the lower plate 80 (this contact area is defined as A₁) is larger than the reference area, while the contact area between each of the elastic bodies 83 to 85 and the lower plate 80 is equal to the reference area. Note that the attachment 10e may be configured so that the contact area between each of the elastic bodies 83 to 85 and the lower plate 80 in this condition becomes smaller than reference area. Here the reference area indicates the contact area between each of the elastic bodies 82 to 85 and the lower plate 80 under the condition that no external force is applied to the joystick 92 (all the contact areas are equal).

Similarly, when a force tilting the joystick 92 is applied in the direction (direction D₂ in FIG. 12) toward the area where elastic body 83 is arranged, pressure having a strength in accordance with the magnitude of this force is applied to the elastic body 83 from above (from the upper plate 91 side), while no pressure is applied to the elastic bodies 82, 84, and 85. In this case, only the contact area between the elastic body 83 and the lower plate 80 (this contact area is defined as A₂) is larger than the reference area, while the contact area between each of the elastic bodies 82, 84, and 85 and the lower plate 80 is equal to the reference area. Note that the attachment 10e may be configured so that the contact area between each of the elastic bodies 82, 84, and 85 and the lower plate 80 in this condition becomes smaller than the reference area.

Moreover, for example, when a force tilting the joystick 92 is applied in the direction (direction D₃ in FIG. 12) between the direction toward the area where elastic body 82 is arranged and the direction toward the area where elastic body 83 is arranged, pressure having a strength in accordance with substantially half the magnitude of this force is applied to both the elastic bodies 82 and 83 from the above (from the upper plate 91 side), while no pressure is applied to the elastic bodies 84 and 85. In this case, the contact area between the elastic body 82 and the lower plate 80 and the contact area between the elastic body 83 and the lower plate 80 (each of the contact areas is defined as A₃) are equal to each other and larger than the reference area, while the contact area between each of the elastic bodies 84 and 85 and the lower plate 80 is equal to the reference area. Note that the attachment 10e may be configured so that the contact area between each of the elastic bodies 84 and 85 and the lower plate 80 in this condition becomes smaller than the reference area.

The attachment 10e is configured so that, if the magnitude of a force tilting the joystick 92 is assumed to be constant, the contact area A₃ is smaller than the contact areas A₁ and A₂, and so that the contact areas A₁ and A₂ are equal to each other. Thus, with an increase in the magnitude of a force tilting the joystick 92, the contact areas A₁, A₂, and A₃ also increase.

Image data transmitted in succession from the image processing part 24 includes information specifying the contact area between each of the elastic bodies 82 to 85 and the lower plate 80. Moreover, there is correlation between each of the contact areas (area ratio of each contact area) and the magnitude and direction of the force tilting the longitudinal axis of the joystick 92 toward the upper plate 91. Using this information, the CPU 11 detects each contact area based on the image data from the image processing part 24, and detects, based on the detected each contact area, the magnitude and direction of the force described above.

As a method of detecting each contact area, the same method as that shown in Example 5 is used. As colors of the elastic bodies 82 to 85, four colors are adopted, which are different from one another. In this case, no attention needs to be paid to which pixel data corresponds to which elastic body. For example, when the elastic body 82 is pink and the elastic bodies 83 to 85 are of different colors that can be discriminated from pink, detecting the area of the region appearing pink (that is, the contact area between the elastic body 82 and the lower plate 80) in the entire photographing region of the camera 2 through binarization processing or the like permits detection of the contact area between the elastic body 82 and the lower plate 80 while discriminating it from other contact areas.

The CPU 11, upon execution of the game program described above, treats data representing the detected magnitude and direction of the force described above (contact areas between each of the elastic bodies 82 to 85 and the lower plate 80) as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

The attachment 10e is used for, for example, a game in which flight control of an aircraft or the like is performed, and is used as a so-called joystick for performing control of the flight direction and flight speed of the aircraft simultaneously. Performing operation of the game with the joystick 92 permits more complicated operation than is achieved by the cross-shaped key (switches 5c to 5f in FIG. 1).

### EXAMPLE 7

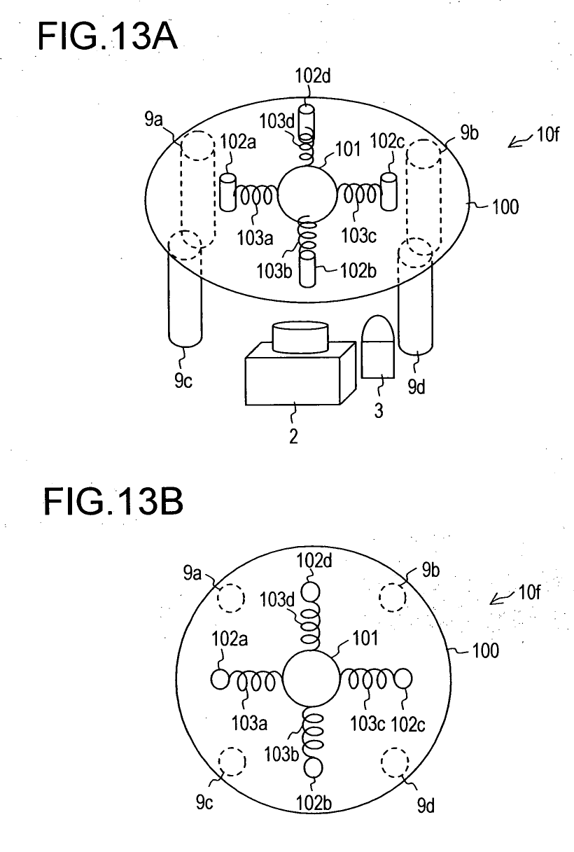

Next, Example 7 will be described. In Example 7, the attachment 10f is fitted to the case 8. FIG. 13A is an enlarged perspective view of the peripheral portion of the attachment 10f. FIG. 13B is a plan view of the attachment 10f as viewed from above. Note that the case 8 is omitted and thus not shown in FIGS. 13A and 13B. Moreover, note that an upper plate which is provided above a lower plate 100 in the attachment 10f is omitted and thus not shown in FIGS. 13A and 13B for the purpose of clearly showing the main part of the attachment 10f.

The attachment 10f is so structured as to have: fitting rods 9a, 9b, 9c, and 9d; a lower plate 100; a globe 101 of a spherical shape as a moving body; spring support rods 102a, 102b, 102c, and 102d; and springs 103a, 103b, 103c, and 103d as elastic bodies.

The lower plate 100 is a plate-like body having a circular shape as viewed from above, and fixed at the peripheral part thereof to the fitting rods 9a, 9b, 9c and 9d. The spring support rods 102a, 102b, 102c, and 102d are placed at four points equidistant from the center of the circular body of the lower plate 100 as viewed from above. The spring support rods 102a, 102b, 102c, and 102d each have the shape of a cylinder, with one end surface thereof fixed to the top surface of the lower plate 100 (surface on the side opposite to the case 8) and with the other end surface thereof fixed to the upper plate (not shown) sandwiching the spring support rods 102a to 102d with the lower plate 100.

The spring support rods 102a, 102b, 102c, and 102d are all identical, and a line linking together the centers of the spring support rod 102a and 102c (or the center of gravity) and a line linking together the centers of the spring support rods 102b and 102d (or the center of gravity) are orthogonal to each other.

The springs 103a, 103b, 103c and 103d are, for example, herical springs, and are fixed at one end thereof to the spring support rods 102a, 102b, 102c, and 102d, respectively. The springs 103a, 103b, 103c and 103d are in contact at the other end thereof with the outer circumference of the globe 101 in such a manner as to sandwich the globe 101 from the four directions. More specifically, the springs 103a to 103d are arranged so that, when the spring 103a extends, the spring 103c contracts accordingly with this extension of the spring 103a, and when the spring 103a contracts, the spring 103c extends accordingly with this contraction of the spring 103a and also so that, when the spring 103b extends, the spring 103d contracts accordingly with this extension of the spring 103b, and when the spring 103b contracts, the spring 103d extends accordingly with this contraction of the spring 103b.

The globe 101 is sandwiched between the lower plate 100 and the upper plate (not shown), and moves while making contact with the lower plate 100 in accordance with the contraction state of the springs 103a, 103b, 103c, and 103d. For example, when the case 8 is oscillated drastically in the direction from the spring support rod 102c toward the spring support rod 102a (that is, if the acceleration of the case 8 in this direction is increased from zero), the globe 101 moves toward the spring support rod 102c, accompanying contraction of the spring 103c and extension of the spring 103a. When the acceleration of the case 8 is zero, the globe 101 is in contact with the lower plate 100 at the circular center thereof as viewed from above.

The camera 2 performs moving image photographing (or still image photographing), targeting the globe 101 as a main subject from the bottom side of the lower plate 100 (the case 8 side) so that the entire lower plate 100 or an entire region where the globe 101 can move falls within the photographing region. The camera 2 and the attachment 10f are arranged so that the contact portion between the lower plate 100 and the globe 101 when the acceleration of the case 8 is zero substantially agrees with the center of the photographing region. The LED 3 irradiates the bottom surface side of the lower plate 100 with light so as to illuminate the photographing region of the camera 2.

The upper plate 100 and the globe 101 are formed of, for example, resin material. In order to permit the camera 2 to capture the globe 101 (the contact portion between the lower plate 100 and the globe 101) as a subject as clearly as possible, for example, the colors of the lower plate 100 and the globe 101 are thin white and pink, respectively, for the same reason as described in Example 1.

The color combination described above is provided as one example, and any color can be adopted as long as the portion where the globe 101 and the lower plate 100 make contact with each other can be discriminated from the outside scene by the camera 2. For example, the lower plate 100 may be arbitrarily half transparent in color, while the globe 101 may be arbitrarily opaque in color.

Image data transmitted in succession from the image processing part 24 includes information specifying the position and movement of the globe 101 in the photographing region. Moreover, the position and movement of the globe 101 permits specifying the degree and direction of acceleration of the case 8. Using this information, the CPU 11 detects the position and movement of the globe 101 in the photographing region based on the image data from the image processing part 24, and detects the degree and direction of acceleration of the case 8 based on the detected position and movement.

The method of specifying the position and movement of the globe 101 in the photographing region is the same as the method shown in Example 1 (method of specifying the position and movement of the globe 41 in the photographing region).

Providing a function, table data, or the like representing the relationship between the position (and movement) of the globe 101 in the photographing region and the degree and direction of the acceleration of the case 8 permits the CPU 11 to detect the degree and direction of the acceleration of the case 8. In this manner, the attachment 10f achieves the function of an acceleration sensor.

The CPU 11, upon execution of the game program described above, treats data representing the detected degree and direction of the acceleration (position (and movement) of the globe 101 in the photographing region) as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

The attachment 10f is used for, for example, a golf game in which the flying distance of a golf ball on the game changes depending on the acceleration applied to the case 8 (degree of oscillation of the case 8). The use of the attachment 10f in this manner permits operating the game by a change in the speed in which the case 8 is moved, thereby increasing variation of plays provided by the game apparatus.

The example where the four springs 103a to 103d are used has been provided above. However, for example, if only the degree and direction of acceleration in the direction linking together the spring support rods 102c and 102a is to be detected, the springs 103b and 103d as well as the spring support rods 102b and 102d can be omitted. In this case, a guid may be provided as appropriate so that the globe 101 does not move in directions other than the direction linking together the spring support rods 102c and 102a. Moreover, the example where both the degree and direction of acceleration of the case 8 are detected has been provided above, but if one of them is not required, only the degree of acceleraton or only the direction of acceleration may be detected.

### EXAMPLE 8

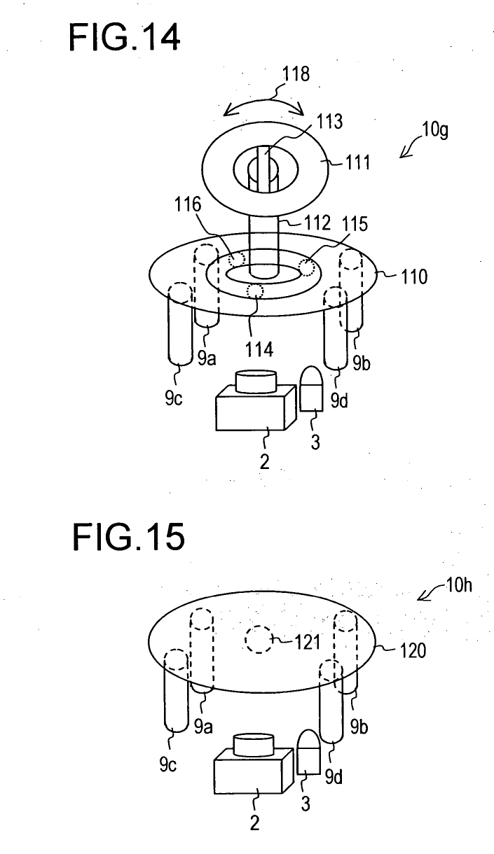

Next, Example 8 will be described. In Example 8, the attachment 10g is fitted to the case 8. FIG. 14 is an enlarged perspective view of the peripheral portion of the attachment 10g. Note that the case 8 is omitted and thus not shown in FIG. 14.

The attachment 10g is so structured as to have: fitting rods 9a, 9b, 9c, and 9d; a lower plate 110; a handle part 111 of a ring-like shape; a shaft 112 of a cylindrical shape; a coupling part 113; and globes 114, 115, and 116 of a spherical shape. The lower plate 110 is a plate-like body having a circular shape as viewed from above, and fixed at the peripheral part thereof to the fitting rods 9a, 9b, 9c and 9d.

When the attachment 10g is fitted to the case 8, the circular-shaped surface of the lower plate 110 becomes parallel to the top surface 18 of the case 8 and the central axis of the shaft 112 is perpendicular to the top surface 18 of the case 8. More specifically, the shaft 112 is rotatably fitted to the lower plate 110 via a bearing part, not shown. The handle part 111 of a ring-like shape is fixed to the shaft 112 via the coupling part 113. Application of an external force to the handle part 111 in such a manner as vehicle handle operation permits the handle part 111 to rotate on the surface parallel to the top surface 18 of the case 8 about the central axis of the shaft 112 in the direction of an arrow 118.

On the bottom surface side of the lower plate 110 (surface on the case 8 side), the globes 114, 115, and 116 are fitted. The globes 114, 115, and 116 are so fitted as to revolve around the central axis of the shaft 112 in conjunction with the rotation of the handle part 111 described above without changing the distance from the central axis of the shaft 112. That is, a rotary body composed of the globes 114, 115, and 116 (a circle line passing through the center of each of the globes 114, 115, and 116, or a region surrounded by this circle line) rotates with the central axis of the shaft 112 as their own axes in conjunction with the rotation of the handle part 111.

The camera 2 performs moving image photographing (or still image photographing), targeting the globes 114 to 116 (the rotary body described above) as main subjects from the bottom side of the lower plate 110 (case 8 side) so that the entire lower plate 110 or the entire region where the globes 114 to 116 can be located falls within the photographing region. For example, the camera 2 and the attachment 10g are arranged so that the shaft 112 substantially agree with the center of the photographing region. The LED 3 irradiates the bottom surface side of the lower plate 110 with light so as to illuminate the photographing region of the camera 2.

In order to permit the camera 2 to capture the globes 114 to 116 as the subjects as clearly as possible, for example, the colors of the lower plate 110 is thin white for the same reason as described in Example 1. The colors of the globes 114, 115, and 116 are, for example, red, blue, and green, respectively. The color combination described above is provided as one example, and any color can be adopted as long as the globes 114 to 116 can be discriminated from the outside scene by the camera 2. For example, the lower plate 110 may be arbitrarily half transparent in color, while the globes 114 to 116 may be arbitrarily opaque in mutually different colors.

Image data transmitted in succession from the image processing part 24 includes information specifying the position and movement of the globes 114 to 116 in the photographing region. Moreover, the position and movement of the globes 114 to 116 permit specifying the rotation state (rotation angle, rotation speed, rotation direction, or the like) of the rotary body composed of the globes 114 to 116. Using this information, the CPU 11 detects the position and movement of the globes 114 to 116 in the photographing region based on the image data from the image processing part 24, and detects the rotation state of the rotary body described above based on the detected position and movement.

In this operation, color-related information (color signals U and V, and the like) in the image data may be used to detect the position and movement of the globes 114 to 116, or brightness information (brightness signal Y) in the image data may be used to detect the position and movement of the globes 114 to 116.

The CPU 11, upon execution of the game program described above, treats data representing the detected rotation state (rotation angle, rotation speed, rotation direction, or the like) of the rotary body as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

The attachment 10g can be used for, for example, a driving game or the like in which a vehicle on the game is driven in accordance with the handle operation of the handle part 111. The use of the attachment 10g in this manner permits game operation to be achieved by the handle operation, thereby increasing variation of plays provided by the game apparatus.

The example where the rotary body described above is composed of the three globes 114 to 116 has been provided above, but the number of globes is not limited to “3”, and may be 4 or more or 2 or less. Moreover, instead of the rotary body composed of the globes 114 to 116, a disc may be provided which has a center thereof fixed to the shaft 112 and also which is divided by a plurality of colors. This disc rotates, following the rotary movement of the handle part 111, rotates in the photographing region of the camera 2 with the central axis of the shaft 112 as its own central axis. The rotation of the disc described above results in incessant change in light received by each pixel of the image sensor 23, in which condition the CPU 11 detects the rotation state (rotation angle, rotation peed, rotation direction, or the like) of the disc described above in the photographing region, based on the image data from the image processing part 24.

### EXAMPLE 9

Next, Example 9 will be described. In Example 9, the attachment 10h is fitted to the case 8. FIG. 15 is an enlarged perspective view of the peripheral portion of the attachment 10h. Note that the case 8 is omitted and thus not shown in FIG. 15.

The attachment 10h is so structured as to have: fitting rods 9a, 9b, 9c, and 9d; a support plate 120; and a temperature indicating material 121. The support plate 120 is a plate-like body having a circular shape as viewed from above, and is fixed at the peripheral part thereof to the fitting rods 9a, 9b, 9c, and 9d.

The temperature indicating material 121 is provided at the center of the bottom surface of the support plate 120 (on the case 8 side). The temperature indicating material 121 is a label applied with a substance exhibiting distinct discoloration in appearance at a set temperature (hereinafter, referred to as a preset temperature). The temperature indicating material 121 may be formed by applying the substance described above to the bottom surface of the support plate 120. The temperature indicating material 121 is a flexible temperature indicating material which changes its color into a predetermined color upon reaching the preset temperature from the low temperature side and which, on the other hand, returns into its original color upon temperature drop.

As the temperature indicating material 121, one temperature indicating material may be provided, or a plurality of temperature indicating materials provided with different preset temperatures may be provided. Moreover, a temperature indicating material may be adopted which changes its color successively within a specific temperature range.

The camera 2 performs moving image photographing (or still image photographing), targeting the temperature indicating material 121 as a main subject from the bottom side of the support plate 120 (case 8 side) so that the entire support plate 120 or the entire temperature indicating material 121 falls within a photographing region. The LED 3 irradiates the bottom surface side of the support plate 120 with light so as to illuminate the photographing region of the camera 2. In order to permit the camera 2 to capture the color of the temperature indicating material 121 as a subject as clearly as possible, the color of the support plate 120 is selected (half transparent, opaque, or the like).

Image data transmitted in succession from the image processing part 24 includes information specifying the color of the temperature indicating material 121. Moreover, the color of the temperature indicating material 121 permits specifying to some extent the ambient temperature of the case 8 as a temperature targeted for measurement. The external air around the case 8 acts as a heat source that changes this ambient temperature, and the aforementioned temperature targeted for measurement is changed by heat energy from the heat source. The CPU 11 detects the color of the temperature indicating material 121 based on the color-related information (the color signals U and V, and the like) included in the image data from the image processing part 24, thereby detecting the ambient temperature of the case 8.

For example, providing table data, or the like representing the relationship between the color of the temperature indicating material 121 and the ambient temperature of the case 8 permits the CPU 11 to detect the ambient temperature of the case 8. In this manner, the attachment 10h achieves the function of a temperature sensor.

The CPU 11, upon execution of the game program described above, treats data representing the detected temperature as a variable, and executes the game program described above referring to the value of this variable. That is, the CPU 11, in accordance with the value of this variable, changes a video signal outputted to the LCD panel 4 and/or an audio signal outputted to the audio control part 12, and changes branch processing of the game program (status of progress of the game).

The use of the attachment 10h permits the status of progress of the game to be changed by the ambient temperature of the game apparatus. For example, possible usage is such that the speed at which the ice on the game melts is increased with an increase in the ambient temperature of the game apparatus, thereby increasing variation of plays provided by the game apparatus.

### EXAMPLE 10

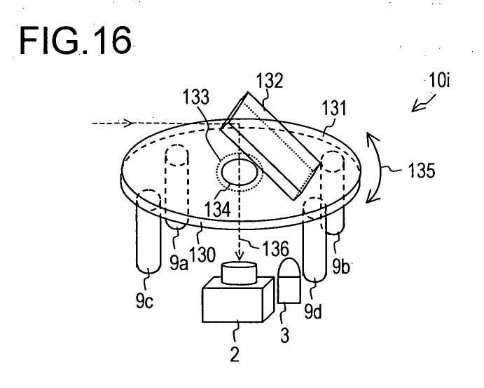

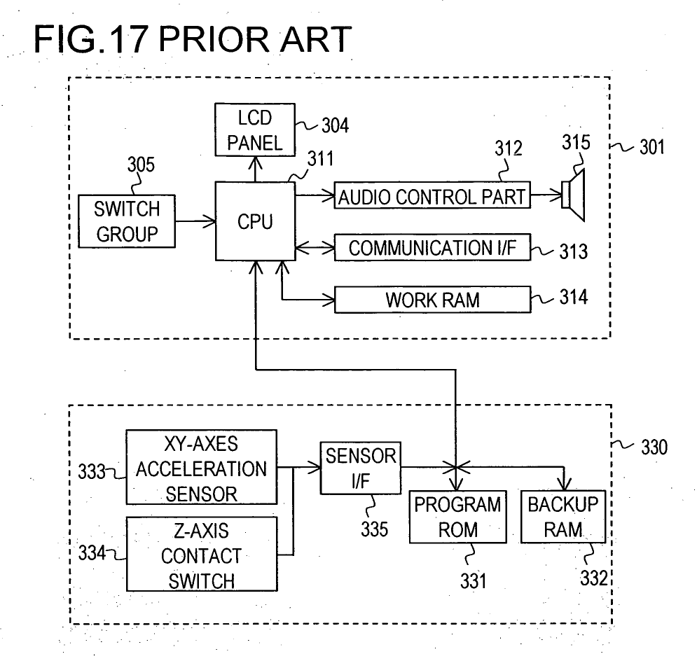

Next, Example 10 will be described. In Example 10, the attachment 10i is fitted to the case 8. FIG. 16 is an enlarged perspective view of the peripheral portion of the attachment 10i. Note that the case 8 is omitted and thus not shown in FIG. 16.

The attachment 10i is so structured as to have: fitting rods 9a, 9b, 9c, and 9d; a support plate 130; a rotating plate 131; and a mirror 132. The support plate 130 is a plate-like body having a circular shape as viewed from above, and is fixed at the peripheral part thereof to the fitting rods 9a, 9b, 9c, and 9d. The rotating plate 131 is a plate-like body having a circular shape as viewed from above, and rotatably fitted on the support plate 130 by a rotational mechanism (bearing or the like), not shown. In the centers of the support plate 130 and the rotating plate 131, circular openings 133 and 134 are respectively provided.

Hereinafter, a case where the case 8 is placed on a desk (not shown) so that the top surface 18 of the case 8 is oriented in parallel to the horizontal plane will be discussed. In this case, the circular-shaped surface of the rotating plate 131 and the circular-shaped surface of the support plate 130 are both parallel to the horizontal plane, while an optical axis 136 of the optical system 21 of the camera 2 is parallel to the vertical direction. The mirror 132 is a rectangular reflecting mirror that is interposed in the optical path of light entering the camera 2, and has an end part thereof fixed to the rotating plate 131 so as to reflect light from a subject located horizontally with the case 8 so that this reflected light enters the image taking surface of the camera 2 via the openings 134 and 133. Thus, the optical axis 136 passes through the centers of the both circular openings 133 and 134, and is bent horizontally by the mirror 132.

The rotating plate 131 rotates on the surface parallel to the top surface 18 of the case 8 with the optical axis 136 as its central axis (in the direction of an arrow 135 in FIG. 16). This rotation is performed by, for example, the user manual operation. The rotation of the rotating plate 131 permits light from any direction of 360 degrees horizontal to the case 8 to enter the image taking surface of the camera 2 while fixing the case 8 at its mounting position.

The camera 2 performs moving image photographing (or still image photographing), targeting, for example, an object located horizontally with the case 8 and reflected on the mirror 132 as a main subject from the bottom side of the support plate 130 (case 8 side) so that the entire support plate 130 or a portion of the mirror 132 viewed from the openings 133 and 134 falls within the photographing region. The LED 3 irradiates the bottom surface side of the support plate 130 with light so as to illuminate the photographing region of the camera 2, although this irradiation can be omitted in this example. The color of the support plate 130 is selected so that the camera 2 can capture the subject described above as clearly as possible. The rotation of the rotating plate 131 permits photographing any object or the like from any direction of 360 degrees horizontal with the case 8 while fixing the case 8 at its mounting position.

The CPU 11 executes the game program described above referring to image data obtained by photographing. That is, the CPU 11, in accordance with this image data, changes a video signal outputted to the LCD panel 4 and/or an audio signal outputted to the audio control part 12, and changes branch processing of the game program (status of progress of the game).

For example, there is possible usage in which the progress of the game is changed by an image photographed by the camera 2 (for example, when a subject of a green color is photographed by the camera 2, the state of a character related to green on the game changes, or the like). In this condition, the direction of photographing by the camera 2 can be changed without moving the case 8, thus preventing inconvenience, such as poor visibility of the LCD panel 4 for photographing.

Moreover, the game apparatus body 1 fitted with the attachment 10i can also be used as an image taking apparatus similar to a digital camera or the like. This image taking apparatus is capable of, as described above, photographing any object or the like from a direction of 360 degrees horizontally with the case 8 while fixing the case 8 at its mounting position. When this game apparatus body 1 is used as an image taking apparatus equivalent to a digital camera or the like, the CPU 11 subjects image data from the image processing part 24 to compression processing or the like, then stores it into a memory (memory card or the like), not shown, and also displays this image data as an image on the LCD panel 4.

### EXAMPLE 11

Next, other operation of the game apparatus using the camera 2 (Operation Examples 1 to 4) will be described, as Example 11. Upon the operation of Example 11, the attachment 10i in Example 10 may be used.

In Operation example 1, light entering the camera 2 when the switch 5a (see FIG. 1A) is pressed down is photographed, and each pixel data of image data obtained by this photographing is binarized based on a predetermined rule. For example, the intensity of a signal R of each pixel data (red component of light received by each pixel) is binarized with a predetermined threshold value. The number of pixels providing “1” by the binarization described above is treated as a point on the game. Then, a game is configured such that this point is compared with another point obtained in the same manner to compete therewith for excellence (for example, a winner is the one who photographs a redder object in the game). In this manner, the game is configured while considering image data as a card in a so-called card game.

In Operation Example 2, to an arbitrary portion of the user (a finger, arm, face, or the like), a label colored red, green, or the like is attached, and the portion of this label is photographed by the camera 2. Then, the progress of the game is changed depending on the movement or the like of this label. For example, a game is configured such that, with a label attached around the mouth, a character on the game eats food on the game by opening and closing movement of the mouth. The CPU 11 analyzes the color-related information included in the image data (color signals U and V, and the like) to thereby detect the position and movement of the color of the label attached around the mouth, whereby the opening and closing movement of the mouth is detected.

In Operation Example 3, at the outer periphery of the game apparatus, a colored object is arranged. For example, a red pole is arranged on the left side of the game apparatus, while a yellow pole is arranged on the right side thereof. The camera 2 determines, by using the color-related information (color signals U and V, and the like) included in the image data, whether or not an image photographed by the camera 2 includes the poles described above. Based on this determination result, the orientation of the case 8 can be determined. Then, in accordance with this determination result, the progress of the game can be changed.

In Operation Example 4, a bar code printed on an object in a plurality of colors, such as red, blue, green, and the like is photographed by the camera 2. The CPU 11, based on brightness information and color-related information included in image data, reads information represented by the bar code, and has this information reflected on the game. For example, a character in accordance with the information represented by the bar code is caused to appear on the game. The information volume can be increased by providing information to the color of the bar (or color combination).

### MODIFIED EXAMPLE AND THE LIKE

Next, modified examples and the like of the configuration and operation of the game apparatus will be illustrated below. A term “attachment” described below indicates an arbitrary attachment from among those described in Examples 1 to 9 (the attachments 10 to 10h), or the attachment 10i in Example 10, or modified attachments of these attachments.

The attachments are selectively fitted to the case 8, and the items indicated in the examples can be arbitrarily combined. For example, on one attachment, the members composing the attachment 10b shown in FIGS. 8A and 8B and the members composing the attachment 10f shown in FIGS. 13A and 13B may be loaded. When this attachment is fitted, the game apparatus can achieve both the operation shown in Example 3 (function as a magnetic sensor) and the operation shown in Example 7 (function as an acceleration sensor).

To avoid a subject to be originally captured through photographing by the camera 2 from being buried in the outside scene, for example, in Example 1, an example has been indicated in which the color of the lower plate 44 is thin white, although this function may be assigned to the upper plate 40. That is, for example, the upper plate 40 may be thin white and the lower plate 44 may be transparent. The modification is applicable in the same way to each example.

Moreover, between the camera 2 and the attachment, or on the case 8 around the camera 2 located below the attachment, a silver-colored reflective film (not shown) may be provided. Reflecting the interior light or the sun light by this reflective film can brighten the photographing region of the camera 2. If it can be determined that predetermined brightness can be ensured even with the LED 3 turned off (this determination is made, for example, based on the intensity of a brightness signal Y included in the image data), the LED 3 can be turned off to reduce the electrical power consumption (or the condition in which the LED 3 is turned off is sustained). If the predetermined brightness described above cannot be ensured with the LED 3 turned off, the LED 3 may be turned on. Furthermore, depending on the specifications of the reflective film or the game apparatus, the LED 3 itself can also be omitted from the game apparatus body 1.

The portion of the case 8 where the attachment is fitted may be formed to be concave so that the attachment does not protrude upward from the top surface 18 of the case 8.

Moreover, depending on the attachment type, the game apparatus body 1 may be used by being inverted upside down or by being oriented horizontally. The contents of display on the LCD panel 4 may also be rotated in accordance with the usage direction.

For example, in a case of a game in which a two-wheel vehicle (so-called motorbike) is operated by using the attachment 10 shown in FIGS. 4A and 4B, the game screen is displayed with the attachment 10 side of the LCD 4 being located on the upper side of the game screen so that the operation can be performed with the portion of the attachment 10 being located at the top (with the portion of the attachment 10 facing the game apparatus body 1 in the direction remote from the user). Then, the game is configured such that, in conjunction with the tilt angle of the case 8, handle operation of the two-wheel vehicle on the game is performed, and the acceleration state is operated of the two-wheel vehicle with the cross-shaped key switch 5c pressed down.

On the other hand, in a case of a music game in which the upper plate 81 is tapped by fingers to play the musical instrument artificially, by using the attachment 10d shown in FIGS. 10A and 10B, the game screen is displayed with the attachment 10d side of the LCD 4 being located on the lower side of the game screen so that the operation can be performed with the portion of the attachment 10d being located at the bottom (with the portion of the attachment 10d facing the game apparatus body 1 in the direction approaching the user). This consequently resolves inconvenience such that the LCD panel 4 is made less visible by the hand of the user who is operating the attachment 10d.

Moreover, the attachment-fitted part composed of the fitting holes 6a to 6d, the camera 2, and the LED 3 may be separated from the game apparatus body 1. In this case, the attachment-fitted part described above is provided in an attachment case (not shown) different from the case 8, so that a signal from the camera 2 (for example, signal representing the image data described above) is transmitted to the game apparatus body 1 with or without wires. Moreover, in the attachment case described above, the switches 5a to 5f may be further loaded. Furthermore, the attachment case described above may be freely attachable and detachable to and from the case of the game apparatus body 1. In this case, the attachment case is detached from the case of the game apparatus body 1 for use as appropriate.

The attachments in Examples 1 to 9, the camera 2 as an image taking part, and the CPU 11 function as a sensing apparatus. This sensing apparatus detects physical information (the degree of inclination, the temperature of an object to be measured by the temperature indicating material 121 (FIG. 15), or the like) of a predetermined type that changes in accordance with external factors, such as a force that changes the inclination of the case 8 (a force of operation by the user, or the gravity force), a heat energy that changes the temperature described above, and the like. Moreover, the attachments in Examples 1 to 9 each function as a subject state change part that changes the state of the subject (for example, the position and movement of the globe 41 in FIGS. 4A and 4B) in accordance with the external factor described above, and the CPU 11 functions as a detection part that detects the physical information described above.

Then, various types of attachments as a subject state change part are selectively fitted to the case 8 in a freely attachable and detachable manner, and physical information in accordance with the attachment fitted is detected. That is, the same camera 2 and CPU 11 can be used to detect various types of physical information, thus permitting, for example, adoption of a game operation method (as appropriate) for each attachment in accordance with game contents with low-cost configuration that only requires replacement of the attachment.

Moreover, the program ROM31 and/or the work RAM 14 function as a program storage part that stores a game program, and the CPU 11 functions as a program execution part that executes this game program.

The invention is applicable as a sensing apparatus that detects various types of physical information, and also applicable to a program execution apparatus such as a game apparatus or the like provided with this sensing apparatus. In addition, the invention is also applicable to an image taking apparatus such as a digital camera, and a program execution apparatus such as a game apparatus provided with a function of the aforementioned image taking apparatus.

What is claimed is:

1. A sensing apparatus for detecting physical information of a predetermined type which changes in accordance with an external factor, the sensing apparatus comprising:
an image taking part;
a subject state change part which includes a subject of the image taking part and which changes a state of the subject in accordance with the external factor; and
a detection part which detects the physical information based on image data obtained by photographing the subject by the image taking part.

2. A sensing apparatus according to claim 1,
wherein the subject state change part is fitted in a freely attachable and detachable manner to a case fitted with the image taking part.

3. A sensing apparatus according to claim 1,
wherein, as the subject state change part, there are at least a first subject state change part and a second subject state change part,
wherein the first subject state change part includes as the subject a first subject of the image taking part, and changes a state of the first subject in accordance with a first external factor as the external factor,
wherein the second subject state change part includes as the subject a second subject of the image taking part, and changes a state of the second subject in accordance with a second external factor as the external factor,
wherein the first and second subjects are different from each other, and the first external factor and the second external factor are external factors of mutually different types,
wherein the first and second subject state change parts are fitted in a freely attachable and detachable manner and also selectively to the case fitted with the image taking part,
wherein, when the first subject state change part is fitted to the case, the detection part detects first physical information as the physical information based on image data obtained by photographing the first subject, and when the second subject state change part is fitted to the case, the detection part detects, as the physical information, second physical information of a type different from that of the first physical information based on image data obtained by photographing the second subject.

4. The sensing apparatus according to claim 1,
wherein the subject state change part includes as the subject a moving body that moves within a photographing region of the image taking part in accordance with inclination of a case fitted with the image taking part,
wherein the external factor is a force which changes the inclination, and
wherein the detection part detects, based on the image data, detects at least one of a position and movement of the moving body in the photographing region to thereby detect as the physical information at least one of a degree of the inclination and a change thereof.

5. The sensing apparatus according to claim 4,
wherein the subject state change part has a convex or concave surface provided in the photographing region of the image taking part, and
wherein the moving body moves along the surface by gravity force when the inclination changes.

6. The sensing apparatus according to claim 1,
wherein the subject state change part includes a surface provided in a photographing region of the image taking part and, as the subject, a moving body, which is movable on the surface,
wherein the external factor is a force which changes a position of the moving body on the surface, and
wherein the detection part, based on the image data, detects as the physical information at least one of the position and movement of the moving body in the photographing region.

7. The sensing apparatus according to claim 1,
wherein the subject state change part includes, as the subject, a magnet provided in a photographing region of the image taking part so as to be rotatable in accordance with a direction of a magnetic field,
wherein the external factor is a magnetic force by the magnetic field which rotates the magnet, and
wherein the detection part, based on the image data, detects a direction of the magnetic force as the physical information.

8. The sensing apparatus according to claim 1,
wherein the subject state change part includes: a rotation axis, and a plurality of blades as the subject which is arranged in a photographing region of the image taking part and which is so fitted as to be rotatable with the rotation axis as a central axis,
wherein the external factor is a force which rotates the a plurality of blades, and
wherein the detection part, based on the image data, detects a rotation state of the plurality of blades as the physical information.

9. The sensing apparatus according to claim 1,
wherein the subject state change part includes, as the subject, a pressure deformable body which is arranged in a photographing region of the image taking part and which changes a shape thereof in accordance with magnitude of pressure applied thereto,
wherein the external factor is the pressure applied to the pressure deformable body, and
wherein the detection part, based on the image data, detects the magnitude of the pressure as the physical information.

10. The sensing apparatus according to claim 9,
wherein the subject state change part includes an upper plate and a lower plate which sandwich an elastic body as the pressure deformable body, and is configured so that a contact area between the pressure deformable body and the lower plate changes in accordance with the magnitude of the pressure applied to the pressure deformable body via the upper plate, and
wherein the detection part, based on the image data, calculates the contact area, and based on the calculated contact area, detects the magnitude of the pressure as the physical information.

11. The sensing apparatus according to claim 1,
wherein the subject state change part includes, as the subject, a plurality of pressure deformable bodies which change a shape thereof depending on magnitude of pressure applied thereto,
wherein the plurality of pressure deformable bodies are arranged at mutually different positions in a photographing region of the image taking part,
wherein the external factor is the pressure applied to the plurality of pressure deformable bodies, and
wherein the detection part, based on the image data, detects, as the physical information, the magnitude of the pressure and a position where the pressure has been applied.

12. The sensing apparatus according to claim 11,
wherein the subject state change part includes an upper plate and a lower plate which sandwich at mutually different positions elastic bodies as the respective pressure deformable bodies, and is configured so that a contact area between each of the plurality of pressure deformable bodies and the lower plate changes in accordance with the magnitude of the pressure applied to each of the pressure deformable bodies via the upper plate and also in accordance with a position where the pressure has been applied, and
wherein the detection part, based on the image data, calculates each contact area, and based on each contact area calculated, detects as the physical information the magnitude of the pressure and the position where the pressure has been applied.

13. The sensing apparatus according to claim 12,
wherein the subject state change part further includes a rod-shaped body which is fitted to the upper plate, and is configured so that the pressure is applied to each of the pressure deformable bodies via the rod-shaped body.

14. The sensing apparatus according to claim 1,
wherein the subject state change part includes as the subject a moving body which moves in a photographing region of the image taking part in accordance with acceleration of a case fitted with the image taking part,
wherein the external factor is a force which changes a degeree of the acceleration, and
wherein the detection part, based on the image data, detects as the physical information at least one of the degree and direction of the acceleration.

15. The sensing apparatus according to claim 14,
wherein the subject state change part further includes a first and a second elastic body which are so provided as to be capable of extending and contracting in a direction which changes the acceleration, and is configured so that with each one end of the first and second elastic bodies fixed, another ends of the first and second elastic bodies sandwich the moving body.

16. The sensing apparatus according to claim 1,
wherein the subject state change part includes as the subject a rotary body which rotates in a photographing region of the image taking part,
wherein the external factor is a force which rotates the rotary body, and
wherein the detection part, based on the image data, detects a rotation state of the rotary body as the physical information.

17. The sensing apparatus according to claim 1,
wherein the subject state change part includes a temperature indicating material which is arranged in a photographing region of the image taking part and which changes a color thereof in accordance with a temperature of an object to be measured,
wherein the external factor is heat energy from a heat source which changes the temperature, and
wherein the detection part, based on the image data, detects the temperature as the physical information.

18. A program execution apparatus comprising a program storage part which stores a program and a program execution part which executes the program, the program execution apparatus further comprising the sensing apparatus according to claim 1,
wherein the program execution part executes the program by referring to, as a variable, the physical information detected by the detection part of the sensing apparatus.

19. An image taking system comprising:
an image taking part,
a case which is fitted with the image taking part,
a rotating plate which has an opening and which is fitted to the case so as to be rotatable with an optical axis of an optical system of the image taking part as a central axis, and
a mirror which is fixed to the rotating plate and which reflects light from a first subject so that the light enters the image taking part via the opening.

20. The image taking system according to claim 19,
wherein the rotating plate is freely attachable and detachable to and from the case,
wherein the rotating plate and a subject state change part which includes a second subject of the image taking part and which, in accordance with an external factor, changes a state of the second subject are selectively fitted to the case in a freely attachable and detachable manner,
wherein the image taking system further includes a detection part, and
wherein, when the subject state change part is fitted to the case, the detection part detects physical information of a predetermined type which changes in accordance with the external factor based on image data obtained by photographing the second subject.
